(19) United States
(12) Patent Application Publication
(10) Pub. No.: US 2024/0370802 A1
(43) Pub. Date: Nov. 7, 2024

(54) SYSTEM AND METHOD FOR PHYSICAL CLIMATE RISK INDICATORS

(71) Applicant: RISKTHINKING.AI INC., Toronto (CA)

(72) Inventor: Ron Samuel DEMBO, Toronto (CA)

(21) Appl. No.: 18/652,241

(22) Filed: May 1, 2024

Related U.S. Application Data
(60) Provisional application No. 63/464,427, filed on May 5, 2023.

(51) Int. Cl. G06Q 10/0635

(52) U.S. Cl. CPC G06Q 10/0635

(57) ABSTRACT

Embodiments described herein relate to computer systems for measuring climate financial risk and opportunity. Embodiments described herein relate to computer systems that automatically generate physical climate risk indicators. Embodiments described herein relate to computer systems that generate integrated physical and transition risk visualizations for computer interfaces and provide access to physical climate risk indicators via an application programming interface.

### CROSS REFERENCE TO RELATED APPLICATION

The application claims all benefit including priority to U.S. Provisional Patent Application No. 63/464,427, filed on May 5, 2023, and entitled “SYSTEM AND METHOD FOR PHYSICAL CLIMATE RISK INDICATORS”, the entire contents of which is hereby incorporated by reference.

### FIELD

The improvements generally relate to the field of computer modelling, software engineering, climate science, classification standards, simulations, scenario generation, risk management, taxonomies, machine learning, and natural language processing. The improvements relate to computer systems that automatically generate climate risk indicator data, and provide real-time visualizations and representations of climate risk indicators for computer interfaces. The computer systems implement enterprise risk management in a scalable, consistent, auditable and reproducible manner.

### INTRODUCTION

Embodiments described herein relate to computer systems for measuring climate financial risk and opportunity. Embodiments described herein relate to computer systems that automatically generate physical climate risk indicators. Embodiments described herein relate to computer systems that generate integrated physical and transition risk analytics.

### SUMMARY

Embodiments described herein relate to computer systems that automatically generate physical climate risk indicators. Embodiments described herein relate to computer systems that generate integrated physical and transition risk analytics. The system has a hardware processor with a communication path to the non-transitory memory to store generated physical climate risk indicator data and other data computed by system.

In accordance with an aspect, there is provided a computer system for physical climate risk indicators. The system has: non-transitory memory storing location data, climatology data, risk factor data, risk indexes, distributions of risk projections. The risk factor data relates to different types of risk factors such as climate risk factors, policy risk factors, and social risk factors. The risk factors are made up of the risk indexes. The risk indexes relate to different types of risk indexes such as climate risk indexes, policy risk indexes, and social risk indexes. Climate risk indexes can be transition risk indexes and physical risk indexes. The system has a hardware processor with a communication path to the non-transitory memory to: generate physical climate risk indicators in response to queries by a client application; and store the physical climate risk indicators in the non-transitory memory; a computer device with a hardware processor having the client application to transmit queries to the hardware processor and an interface to generate visual elements at least in part corresponding to the physical climate risk indicators and the risk metrics received in response to the queries.

In some embodiments, the hardware processor can construct the distributions of climate risk projections, by, for each climate risk factor, constructing forward-looking distributions of projected values for the climate risk factor for a given location and future climatology projection; compute, for each climate risk factor, a risk impact and an opportunity impact, wherein the risk impact indicates a magnitude of negative impact a location is set to experience relative to a baseline, wherein the opportunity impact indicates a magnitude of positive impact the location is set to experience relative to the baseline; compute, for each climate risk factor, an upside probability and a downside probability, the downside probability measuring a likelihood that a projection is inside a risk area relative to the baseline and the upside probability measuring a likelihood that the projection is inside an opportunity area relative to the baseline; generate, using the distributions of climate risk projections as input, multifactor scenario sets, wherein the multifactor scenario sets represent an effect that a plurality of climate risk factors have on a physical asset over a time horizon, wherein the multifactor scenario sets account for permutations of the plurality of climate risk factors over the time horizon, wherein the multifactor scenario sets form a spanning set as a binary scenario tree of nodes, each branch of the tree representing a possible combination of climate risk factors and the upside probability and the downside probability for the climate risk factors, the spanning set having edges connecting the nodes to create climate pathways, wherein the processor constructs the spanning set to enable analysis of different types of risk indexes independently or as a combination; generate multifactor climate risk indicators using the multifactor scenario sets, the climate risk indicators comprising factor risk indicators, factor opportunity indicators, and climate risk indicators, wherein a factor risk indicator measures a location's degree of risk exposure to a climate risk factor, wherein a factor opportunity indicator measures the location's degree of opportunity exposure to the climate risk factor, wherein a physical climate risk indicator measures the exposure of an entity or physical asset to a climate risk potential relative to an opportunity potential, wherein the physical climate risk indicators provide downside climate risk and upside climate risk of a physical asset or a group of physical assets, the downside risk defined as an impact weighted downside probability on the asset or the group of assets and the upside risk defined as an impact weighted upside probability on the asset or the group of assets, wherein the climate risk indicators comprise physical climate risk indicators and transition (economic) climate risk indicators; transmit at least a portion of the multifactor climate risk indicators; and store the multifactor climate risk indicators in the non-transitory memory.

The system can have an application programming interface to provide access to the hardware processor to provide input data and receive output data.

The system can have a computer device with a hardware processor having a client application to transmit input data to the application programming interface and an interface to generate visual elements at least in part corresponding to the portion of the multifactor climate risk indicators received in response to the input data, wherein the interface receives input to navigate financial impact of climate risk into the future for a physical asset of an entity, for any climate pathway, for any time period.

In some embodiments, the climate risk factors comprise transition (economic) risk factors and physical risk factors, wherein transition risk factors comprise energy prices for various types of energy, energy consumption by sector for various types of energy, solar capital cost, wind capital cost (offshore and onshore), GDP growth, an agriculture price index and other financial variables, wherein physical risk factors comprise heatwave, sea level rise, flood and other non-financial climate variables.

In some embodiments, the interface navigates the financial impact of climate risk with respect to different categories comprising a carbon category, a labour category, and a capital category. For example, for carbon, the system can generate future distributions of carbon price by region and apply them to the entity's carbon emissions (current and expected) to estimate financial exposure to carbon price. For example, for labour, the system can generate future distributions of heat stress (e.g., wet bulb globe temperature) and apply them to the entity's employment data (e.g., labour time and output by occupation) to estimate heat stress-induced labour reduction. Risk thresholds are based on third-party empirical evidence. For example, for capital, the system can apply damage functions (which vary by risk factor, region, and physical asset classification) to future distributions of relevant physical risk factors to estimate impact in terms of annual output reduction or asset replacement cost.

In some embodiments, the hardware processor aligns the climate risk factor data geospatially, temporally, and by climate pathway.

In some embodiments, the hardware processor scales the climate risk factor data relative to the baseline.

In some embodiments, the hardware processor identifies the physical asset or the group of physical assets of the physical climate risk indicators by identifying physical assets owned or operated by each node in a corporate network of a company and generate, for each physical asset, asset attributes about asset type, emissions, financial data, ownership, physical location (latitude and longitude, country, state, postal code), and size.

In some embodiments, the hardware processor generates the multifactor scenario sets to measure climate financial risk using stochastic analysis.

In some embodiments, wherein, for each risk factor, a node stores a quantitative value derived for the upside probability or the downside probability for the risk factor.

In some embodiments, the physical climate risk indicators indicate physical and transition risk exposure at any time point in the future, under any climate pathway, for the climate risk factors, for any asset location.

In another aspect, embodiments described herein provide a method for computer models for physical climate risk indicators, or a computer readable medium with instructions to be executed by a processor to generate computer models for physical climate risk indicators.

Many further features and combinations thereof concerning embodiments described herein will appear to those skilled in the art following a reading of the instant disclosure.

### DESCRIPTION OF THE FIGURES

FIG. 1 shows an example system for physical climate risk indicators;

FIG. 2 shows an example of Simple Precipitation Intensity Index projections;

FIG. 3 illustrates an example spanning set with four climate risk factors;

FIG. 4 illustrates an example distribution of Simple Precipitation Intensity Index;

FIG. 5 shows an example graph of the distribution of Simple Precipitation Intensity Index Projections;

FIG. 6 illustrates results from example empirical validation testing of maximum daily temperatures;

FIG. 7 illustrates results from example empirical validation testing of minimum daily temperatures;

FIG. 8 shows an example graph of downside climate risk across horizons;

FIG. 9 shows an example graph of factor risk and opportunity indicators across horizons;

FIG. 10 is an example graph showing Downside Climate Risk at Global Level;

FIG. 11 is an example graph showing Downside Climate Risk at Country Level;

FIG. 12 is an example interface showing a Map View of Downside Climate Risk;

FIG. 13 is an example graph showing Climate Risk Drivers for Single Asset;

FIG. 14 is an example graph showing Downside Climate Risk of Model Portfolio;

FIG. 15 is an example graph showing Downside Climate Risk by Company in Model Portfolio;

FIG. 16 is an example graph showing Primary Risk Drivers;

FIG. 17 is an example graph showing Material Risks by Geography;

FIG. 18 is an example graph showing Material Risks by Asset Type;

FIG. 19 is an example graph showing Downside Climate Risk;

FIG. 20 is an example graph showing Factor Risk Indicators;

FIG. 21 is an example graph showing Primary Risk Drivers for Model Portfolio;

FIG. 22 shows an example asset taxonomy;

FIG. 23 shows an example graph of impact functions for assets;

FIG. 24 shows an example data processing pipeline;

FIG. 25 shows example data storage; and

FIGS. 26 to 38 show different example visualizations at interface.

### DETAILED DESCRIPTION

Embodiments described herein relate to computer systems for physical climate risk indicators. According to an aspect, there is provided a computer system for integrated physical and transition risk analytics. While description of system 100 is for physical Climate Risk Indicators, the methodology can be used by system 100 for physical asset data, transition risk indicators, financial impact, credit risk impact, pricing, facilities and other solutions.

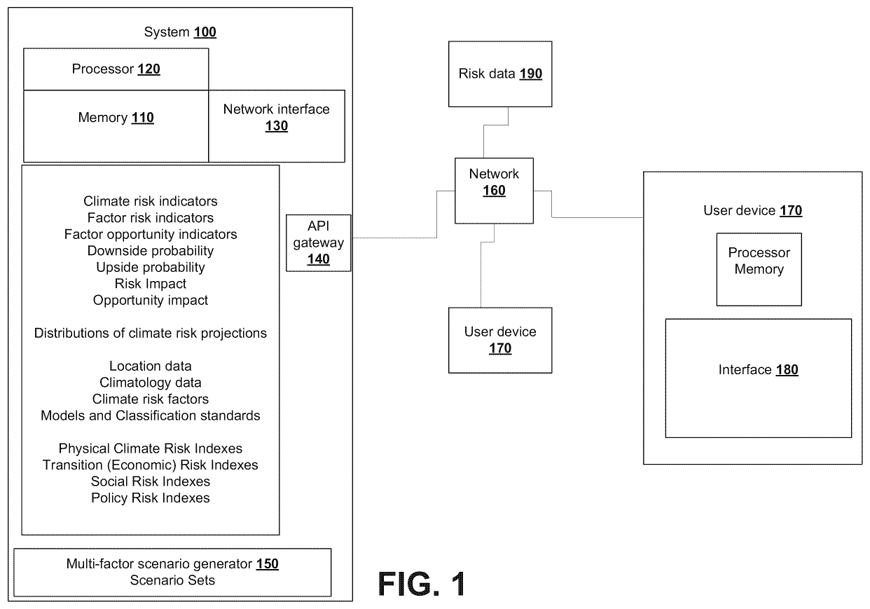

Referring to FIG. 1, there is shown an example system 100 for physical climate risk indicators. System 100 has servers and hardware components to automatically generate physical climate risk indicators and provides user devices 170 with access to the physical climate risk indicators over a network 160. System 100 can receive raw risk data 190 for processing.

System 100 has non-transitory memory 110 storing location data, climatology data, climate risk factor data, risk indexes, distributions of climate risk projections. The risk factors are made up of risk indexes. For example, system 100 has non-transitory memory 110 storing different types of risk indexes, such as Physical Client Risk Indexes, Transition (Economic Risk Indexes, Social Risk indexes, Policy Risk Indexes, and so on. A risk index can be a tool to measure, evaluate, and/or estimate a level of risk. System 100 has a hardware processor 120 with a communication path to the non-transitory memory 110. System 100 has a network interface 130 and an application programming interface (API) gateway 140.

The hardware processor 120 can construct the distributions of climate risk projections. For example, the hardware processor 120 can, for each climate risk factor, construct forward-looking distributions of projected values for the climate risk factor for a given location and future climatology projection.

The hardware processor 120 can compute, for each climate risk factor, a risk impact and an opportunity impact. The risk impact indicates a magnitude of negative impact a location is set to experience relative to a baseline. The opportunity impact indicates a magnitude of positive impact the location is set to experience relative to the baseline.

The hardware processor 120 can compute, for each climate risk factor, an upside probability and a downside probability. The downside probability measuring a likelihood that a projection is inside a risk area relative to the baseline and the upside probability measuring a likelihood that the projection is inside an opportunity area relative to the baseline.

The hardware processor 120 uses scenario generator 150 (e.g. code stored in memory that can be executed by the hardware processor 120) to compute generate, using the distributions of climate risk projections as input, multifactor scenario sets that represent an effect that a plurality of risk factors have on a physical asset over a time horizon. There can be different types of risk factors, such as climate risk factors, policy risk factors, and social risk factors. Climate risk factors can include transition (economic) risk factors and physical climate risk factors. The multifactor scenario sets account for permutations of the climate risk factors over the time horizon. The multifactor scenario sets form a spanning set as a binary scenario tree of nodes. Each branch of the tree representing a possible combination of climate risk factors and the upside probability and the downside probability for the climate risk factors. The spanning set having edges connecting the nodes to create climate pathways. The spanning set to enable analysis of different types of risk indexes independently or as a combination. In some embodiments, the hardware processor 120 generates the multifactor scenario sets to measure climate financial risk using stochastic analysis. A node of the tree can store a quantitative value derived for the upside probability or the downside probability for a given risk factor.

The hardware processor 120 can generate multifactor climate risk indicators using the multifactor scenario sets. The climate risk indicators can be physical climate risk indicators and transition (economic) climate risk indicators. There can also be policy risk indicators, and social risk indicators. The climate risk indicators include factor risk indicators, factor opportunity indicators, and physical climate risk indicators. A factor risk indicator measures a location's degree of risk exposure to a climate risk factor. A factor opportunity indicator measures the location's degree of opportunity exposure to the climate risk factor. A physical climate risk indicator measures exposure of an entity or physical asset to a climate risk potential relative to an opportunity potential. The physical climate risk indicators provide downside climate risk and upside climate risk of a physical asset or a group of physical assets. The downside risk can be defined as probability weighted downside impact on the asset or the group of assets and the upside risk defined as probability weighted upside impact on the asset or the group of assets. The physical climate risk indicators indicate physical and transition risk exposure at any time point in the future, under any climate pathway, for the climate risk factors, for any asset location.

System 100 can transmit at least a portion of the multifactor climate risk indicators. System 100 can store the multifactor climate risk indicators in the non-transitory memory 110.

System 100 has an API gateway 140 to provide access to the hardware processor to provide input data and receive output data. System 100 connects to a user device 170 (e.g. a computer device with a hardware processor and memory) that has a client application to transmit input data to the API gateway 140. The user device 170 has an interface 180 to generate visual elements at least in part corresponding to the portion of the multifactor climate risk indicators received in response to the input data. The interface 180 can navigate causes of climate risk and financial impact into the future for a physical asset of an entity, for any climate pathway, for any time period.

In some embodiments, the hardware processor 120 aligns the climate risk factor data geospatially, temporally, and by climate pathway. In some embodiments, the hardware processor 120 scales the climate risk factor data relative to the baseline.

In some embodiments, the hardware processor 120 identifies the physical asset or the group of physical assets of the physical climate risk indicators by identifying physical assets owned or operated by each node in a corporate network of a company and generate, for each physical asset, asset attributes about asset type, emissions, financial data, ownership, physical location (latitude and longitude, country, state, postal code), and size.

System 100 can provide a true stochastic (probabilistic) data platform for measuring climate financial risk. In this very uncertain world, stochastic analysis is essential for uncovering the blind spots that result when using single pathway analyses (e.g., SSP1-26).

System 100 enables users to fully understand climate risk exposure at any point in the future, under any climate pathway, for multiple risk factors, wherever their assets are located. System 100 incorporates all random climate risk variables needed to conduct climate risk assessments. System 100 can enable users to stress test physical assets realistically and consistently across all geographies. Access to system 100 is available via an applicant programming interface (API). System 100 may also be used to generate reports as part of a compliance program for regulation or voluntary disclosure rules that require single pathway analysis (e.g., United States Federal Reserve Pilot Climate Scenario Analysis Exercise). System 100 can use multifactor stress testing. Examples of testing and measuring risk that can be implemented by system 100 are provided in PCT Application nos. PCT/CA2021/050743 (entitled SYSTEMS AND METHODS FOR COMPUTER MODELS TO MEASURE AND MANAGE RADICAL RISK USING MACHINE LEARNING AND SCENARIO GENERATION) and PCT/CA2022/050180 (entitled SYSTEMS AND METHODS FOR COMPUTER MODELS FOR CLIMATE FINANCIAL RISK MEASUREMENT) the entire contents of which are hereby incorporated by reference. Examples of climate measurements that can be implemented by system 100 are provided in PCT Application nos. PCT/CA2010/001660 (entitled SYSTEMS AND METHODS FOR COMPUTING EMISSION VALUES), PCT/CA2012/000853 (entitled SYSTEM AND METHOD FOR PROCESSING AND DISPLAYING DATA RELATING TO CONSUMPTION DATA), PCT/CA2012/000800 (entitled SYSTEM AND METHOD FOR GENERATING, PROCESSING AND DISPLAYING DATA RELATING TO CONSUMPTION DATA), and U.S. Pat. No. 8,478,566 (entitled SYSTEMS AND METHODS FOR COMPUTING EMISSION VALUES), the entire contents of which are hereby incorporated by reference.

System 100 provides a solution for institutions measuring climate risk: the physical make-up of their counterparties. System 100 applies Al models to decipher complex network structures of companies (private and public), subsidiaries, and their full constellation of physical assets owned or operated by each node in the corporate network. The platform contains granular information about asset type, emissions, financial data, worldwide ownership structure, physical location (latitude and longitude, country, state, postal code), building size, and more attributes (depending on asset type). Access is available via API.

System 100 can include one or more interfaces, including an interactive user interface to provide access to data and analytics of system 100. With the interactive user interface, users visually navigate causes of climate risk and financial impact into the future—down to a single asset, of a single subsidiary, for any climate pathway, for any time period (e.g. including into future time periods such as until 2100). The software includes data of companies and data from end users. The interactive user interface can be used to make strategy and investment decisions, and to meet reporting requirements, such as the Task Force on Climate-Related Financial Disclosures (“TCFD”), Corporate Sustainability Reporting Directive (“CSRD”), and so on. Example interfaces are described in U.S. Pat. No. 9,390,391 entitled SYSTEM AND METHOD FOR BENCHMARKING ENVIRONMENTAL DATA the entire contents of which is hereby incorporated by reference.

This following provides a high-level overview of the data and methodology applied by system 100 to generate physical Climate Risk Indicators for various interactive computer interfaces. The following also describes tests of the methodology and example use cases of how institutions and corporations might use the data.

### Capturing Radical Uncertainty in Climate Risk

System 100 generates climate risk measurement data. System 100 can compute climate risk measurement data using a large number (e.g. trillions) of data points representing distributions of projections for multiple (e.g. more than 60,000) climate risk factors, at multiple locations (e.g. every location on Earth), and at each climatology (e.g. 20-year periods around the indicated decades from 1850 to 2100). System's 100 methodology culminates in realistic and consistent analytics that measures climate risk.

System's 100 methodology is fully stochastic. Climate change is radically uncertain. There is not a single pathway—and there is not a single pathway and model combination—that can be used to generate reliable climatology projections, especially when measuring risk at scale across multiple factors, geographic locations, and climatologies.

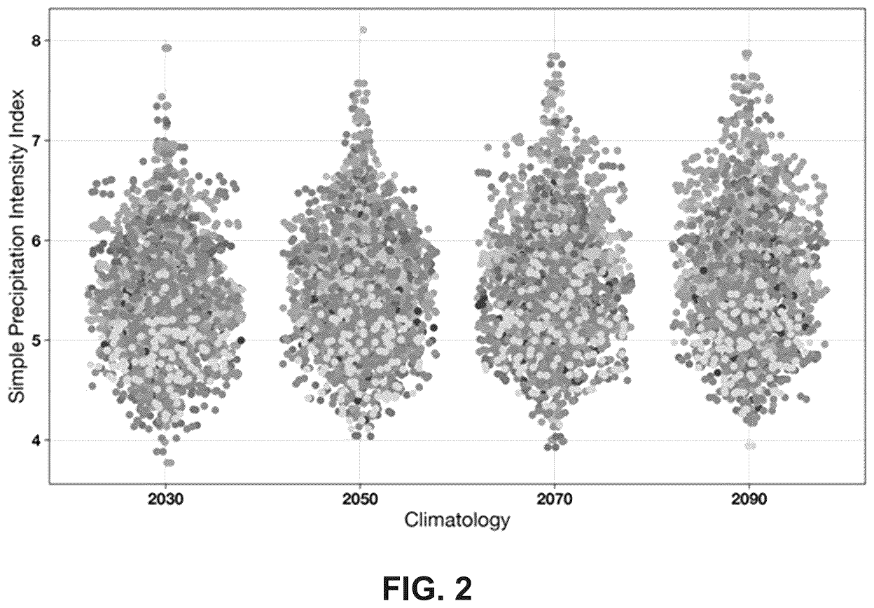

Referring now to FIG. 2, there is shown an example of Simple Precipitation Intensity Index projections for the City of London. Each dot of a different color represents a single projection of a single model or model experiment, for a single pathway per climatology (20-year periods around the indicated dates). For further information on climate scenarios and models is provided herein. In this figure, the range of projections illustrates the uncertainty level between climate projections from different models. Note that the projection values are expanded along the x-axis for visual clarity.

To account for future climate uncertainty at scale, system 100 uses a fully stochastic (probabilistic) methodology. As an example, the approach analyzes entire distributions of climate risk projections built using data from eight possible future pathways (i.e., SSP1-19, SSP1-26, SSP4-34, SSP4-60, SSP2-45, SSP5-34, SSP5-85, SSP3-70) and 22 global climate models. On average, the distribution of a single risk factor for a given location and future climatology projections is made up of more than 1,000 observations.

Accordingly, instead of relying on deterministic measurement of risk, system 100 can analyze entire distributions of risk projections. System 100 enables the capture of low probability yet high impact outcomes (i.e., tail risks).

System 100 can generate multifactor scenarios and multifactor risk indicators.

Simple averages or summations do not constitute realistic representations of the effect multiple risk factors have on a physical asset. To measure total risk comprehensively, the system 100 can account for all permutations of multiple factors.

With distributions of climate risk projections as the input, system 100 generates multifactor scenarios from which it computes multifactor risk indicators. Examples of scenario generation are provided in U.S. Pat. No. 10,558,769 entitled SYSTEMS AND METHODS FOR SCENARIO SIMULATION the entire contents of which is hereby incorporated by reference. At a high-level, a spanning set (i.e., binary scenario tree) is formed with each branch representing a possible combination of upside (i.e., opportunity potential) and downside (i.e., risk potential) of each factor. This technique provides that the best and worst outcomes as part of the spanning set. Since magnitude and probability of upside and downside are accounted for, the best and worst outcomes can be surprising. For example, in most instances the worst outcome does not necessarily correspond to a branch consisting of downside for every risk factor.

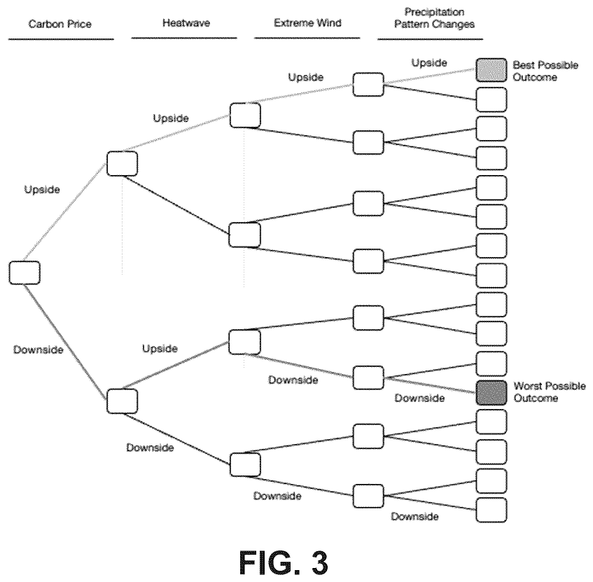

FIG. 3 illustrates an example spanning set with four climate risk factors for the City of London, United Kingdom, 2030. In this example, the worst possible outcome comes from the branch downside-upside-downside-downside-downside. The downside and upside values are derived from the distribution of climate projections and represent the factor's risk or opportunity potential. Since magnitude and probability are accounted for, the worst outcome may not correspond to the branch consisting of a downside for every risk factor. In this example, it happens that the best outcome corresponds to the branch consisting of an upside for every risk factor, but this is not always the case. Further information on the methodology and derivation of upside-downside values is provided herein.

System 100 quantifies the climate risk of entities and portfolios using a bottom-up approach. System 100 can compute risk at the physical asset level and then aggregate upward to any grouping, such as department, postal code, city, county, state, country, sector, asset type, company, and investment portfolio levels. To enable this capability, system 100 can align and store a large number of (e.g. more than 60,000) climate risk factors to (e.g. approximately 33 billion) hexagonal grids, covering a large portion (e.g. the entire surface) of a geographic region (e.g. the Earth). By way of example, the average resolution of the data can be 5.1 square kilometres for the Earth. A much higher resolution is available where the data permits, e.g. resolution of a 100-metre square grid for wildfire climate factor. The bottom-up approach is more robust, and also more transparent.

System 100 can provide an effective exposure scheme to utilize climate risk data in strategic planning, investment analysis, and decision-making. The exposure scheme can generate output data indicating a percentage that an event will occur using models for predicted events and a stochastic approach. Accordingly, system 100 can define downside risk as the probability weighted downside impact on an asset or group of assets, and/or for the upside potential.

System 100 can also express indicators using an alpha-numeric scheme that ranges from Dn to Un, where n is a number (e.g. D5 to U5). Each indicator is composed of two characters. The letter character is either ‘D’, representing downside, or ‘U’, representing upside. The indicators range from 1 to n (e.g. 5). For example, D4 means that the downside risk of climate stress is four times the upside potential. Conversely, U4 means that the upside risk of climate stress is four times the downside potential.

System 100 can also express indicators using an alpha-numeric scheme that ranges from Dn to Un (e.g. D5 to U5). Each indicator is composed of two characters. The letter character is either ‘D’, representing downside, or ‘U’, representing upside. The indicators range from 1 to 5. For example, D4 means that the downside risk of climate stress is four times the upside potential. Conversely, U4 means that the upside risk of climate stress is four times the downside potential.

### Data

System 100 can use a significant amount of data to measure climate risk using a fully stochastic, multifactor, and bottom-up methodology. For example, system 100 can store the distributions of climate projections of 63,000 risk factors for approximately 33 billion hexagonal grids, covering every location on the surface of Earth. This amounts to trillions of data points (petabytes of data). System 100 can generate output data that indicates the company, asset type, and location of physical assets.

The source data can meet a minimum set of integrity requirements, including that they are published by a peer-reviewed journal (e.g., Nature Climate Change), intergovernmental organization (e.g., Intergovernmental Panel on Climate Change), or government agency (e.g., National Oceanic and Atmospheric Administration). Further information on the quality assurance of the data is provided herein.

System 100 can generate third party climate pathways and data.

System 100 can receive input data from different source data, including source physical climate data from the Coupled Model Intercomparison Project Phase Six (“CMIP6”). Created and administered by the World Climate Research Program (“WCRP”), CMIP6 is a consortium of 51 national research centers and universities that create standards for global climate modelling. Having aligned on standards, CMIP6 members assemble all their models into one coupled model. The resulting data are considered the standard in climate science. For example, CMIP6 is the main source for the United Nations Intergovernmental Panel on Climate Change-Sixth Assessment Report (“IPCC-AR6”).

CMIP6 endorses the Scenario Model Intercomparison Project (“ScenarioMIP”), which designed eight climate pathways, also referred to as SSP scenarios. Each pathway then represents a combination of socioeconomic trends, which are called Shared Socioeconomic Pathways (“SSP”), and radiative forcings, which are called Representative Concentration Pathways (“RCP”). ScenarioMIP provides a large initial condition ensemble with historical projections.

The following table is of example shared socioeconomic pathways from O'Neill, Brian et. al. (2016). The Scenario Model Intercomparison Project (ScenarioMIP) for CMIP6. Geoscientific Model Development. 9. 3461-3482. 10.5194/gmd-9-3461-2016.

| Shared | | |
|---|---|---|
| Socioeconomic | | |
| Pathway | Name | Description |
| SSP1 | Sustainability | The world shifts gradually, but |
| | | pervasively, toward a more |
| | | sustainable path, emphasizing |
| | | more inclusive development that |
| | | respects perceived |
| | | environmental boundaries. |
| SSP2 | Middle of the | The world follows a path in |
| | Road | which social, economic, and |
| | | technological trends do not shift |
| | | markedly from historical patterns. |
| SSP3 | Fossil-Fuel | A resurgent nationalism, concerns |
| | Development | about competitiveness and |
| | | security, and regional conflicts |
| | | push countries to increasingly |
| | | focus on domestic or, at most, |
| | | regional issues. |
| SSP4 | Regional Rivalry | This world places increasing |
| | | faith in competitive markets, |
| | | innovation and participatory |
| | | societies to produce rapid |
| | | technological progress and |
| | | development of human capital as |
| | | the path to sustainable development. |
| SSP5 | Inequality | Highly unequal investments in human |
| | | capital, combined with increasing |
| | | disparities in economic opportunity |
| | | and political power, lead to |
| | | increasing inequalities and |
| | | stratification both across and |
| | | within countries. |

In addition to CMIP6, system's 100 methodology utilizes International Best Track Archive for Climate Stewardship (“IBTrACS”) and Aqueduct Floods Hazard Maps data, which are inputs for analyzing cyclone risk and flood risk, respectively. System 100 can also provide an ontology of climate risk data. The ontology helps to classify the multitude of dimensions, frequency, and interconnectedness of risk factors.

System 100 can generate derived physical climate data.

To augment CMIP6 data, system 100 can derive additional (e.g. 58) climate risk indexes, such as sea level rise, flooding, and wet bulb globe temperature. These data can be generated by applying CMIP6 projections to scientifically accepted methodologies endorsed by the WCRP's Expert Team on Climate Change Detection and Indexes (“WCRP ETCCDI”).

System 100 further classifies risk indexes as either chronic or acute. Definitions for chronic and acute risks are sourced from the TCFD. Chronic risks refer to long term shifts in climate patterns, such as sustained higher mean temperatures. Acute risks refer to discrete physical events, such as a cyclone.

### Data Alignment

To manage the processing of large data from disparate sources, system 100 aligns risk variables geospatially, temporally, and by climate pathway. This is step can ensure risk is assessed consistently.

System 100 can implement geospatial alignment. For example, system 100 can leverage the Hexagonal Hierarchical Geospatial Index System (“H3 Index System”), an open-source global grid, to link longitudinal and latitudinal data into a hierarchy of predefined hexagons. System 100 can align each dataset at their native resolution to the closest H3 Index System resolution using bilinear interpolation.

System can implement temporal alignment. For example, system 100 can use climate models to compute projections at either the year, season, or month-year resolution. System 100 can store all data in their most granular form. However, for risk analysis, system 100 can align climate projections to eight 20-year climatologies, which can be referred to as “horizons”: 2010, 2030, 2040, 2050, 2060, 2070, 2080, and 2090. Some risk factors have scarce projections for certain horizons. In cases in which system 100 has at least three horizons of projections, system 100 can account for gaps by applying statistical interpolation.

System can implement scenario alignment. For example, system 100 can use projections from all pathways to conduct a fully stochastic analysis. However, to ensure system 100 can support regulatory and voluntary reporting requirements, system 100 can align CMIP6 pathways to three scenario sets, Paris Aligned Scenarios, National Commitment Scenarios, and No Additional Policies Scenarios. The pathways can be grouped based on their global mean temperature (“GMT”) projections of 2100.

The following table is of example scenario sets of system 100.

| Name | Definition | GMT Rise by 2100 |
|---|---|---|
| Stochastic View | All projections from all | 0.9-7.4 |
| | experiments are included for a | |
| | fully stochastic analysis | |
| Paris Aligned | The Paris Agreement is met, | 0.9-2.4 |
| Scenarios | and the GMT does not increase | |
| | more than 2.0° C. compared | |
| | to pre-industrial times. | |
| National | Current national commitments | 1.7-3.7 |
| Commitment | are met, and the GMT rises by | |
| Scenarios | about 2.5° C. compared to | |
| | pre-industrial times. | |
| No Additional | No further policy action is | 3.0-7.4 |
| Policies | taken to mitigate climate | |
| Scenarios | change, resulting in a global | |
| | mean temperature rise of more | |
| | than 3.0° C. compared to | |
| | pre-industrial times. | |

Note that the range of GMT rise for each scenario set reflects example minimum and maximum projections of all models associated with discrete SSPs. SSPs do not exactly align to one particular outcome of GMT rise but rather a range. For example, SSP1-26, which is part of the Paris Aligned Scenarios, projects GMT rise between 0.9° C. and 2.3° C. by the end of the century.

### Data Weights

System 100 can generate data weights. System 100 weights climate data such that more robust models are given more importance. For example, some pathways are projected by more models than others. To avoid sample bias in the distributions of climate projections, system 100 can weigh data to account for the number of models per pathway.

Additionally, some models are less realistic than others in terms of whether their projections of GMT are scientifically possible given CO2 emissions. This aspect of model performance is measured using a statistic called equilibrium climate sensitivity (“ECS”), which we apply to weigh projections. Similarly, some CMIP6 pathways are widely agreed to be less likely than others given the current state of climate policies, such as SSP4-34. To account for potentially misleading projections, system 100 can apply weights based on structured expert judgement, which jointly with ECS account for potentially misleading projections. Examples of structured expert judgement are provided in U.S. Pat. No. 10,558,769 entitled SYSTEMS AND METHODS FOR SCENARIO SIMULATION the entire contents of which is hereby incorporated by reference.

### Methodology

In some embodiments, system 100 applies a fully stochastic, multifactor, and bottom-up methodology. Distributions of climate projections are algorithmically combined using the spanning set. The climate data is entirely made up of projections by established third-party institutions or by applying the accepted methodology.

Note that system 100 may not model climate data but rather sources peer-reviewed raw climate data for exposure analysis. After collecting the raw data from established institutions, system 100 applies weights to avoid biased results. Further information on the principles of the methodology are provided herein.

System 100 involves scaling distributions of climate projections. The methodology involves multiple interim steps and statistics, each of which can be given terms. Examples of specific terms and their definitions are available in the following table.

| System Term | Definition |
|---|---|
| Downside Probability | Downside probability measures the |
| | likelihood that the projection is |
| | inside the risk area relative to |
| | the baseline. |
| Upside Probability | Upside probability measures the |
| | likelihood that the projection is |
| | inside the opportunity area |
| | relative to the baseline. |
| Risk Impact | Risk impact (or exposure) shows |
| | the magnitude of the negative |
| | impact the location is set to |
| | experience relative to the baseline. |
| Opportunity Impact | Opportunity impact (or exposure) |
| | shows the magnitude of the positive |
| | impact the location is set to |
| | experience relative to the baseline. |
| Factor Risk Indicator | The Factor Risk Indicator measures |
| | the location's degree of risk |
| | exposure to a climate factor. |
| Factor Opportunity | The Factor Opportunity Indicator |
| Indicator | measures the location's |
| | degree of opportunity exposure |
| | to a climate factor. |
| Climate Risk | Climate Risk Indicator is a |
| Indicator | proprietary measurement that |
| | quantifies the exposure of an entity |
| | or an asset to climate risk potential |
| | relative to opportunity potential. |
| Downside Climate | Downside Climate Risk is a |
| Risk | proprietary measurement used to |
| | quantify the exposure of an entity or |
| | an asset to risk potential. |

These are example terms, and other terms may also be used for the various types of risk evaluations or assessments in other embodiments.

For each climate factor, system 100 constructs the forward-looking distribution of projected values. The raw distribution can be either sourced directly from the third-party models or derived using the calculations defined by WCRP.

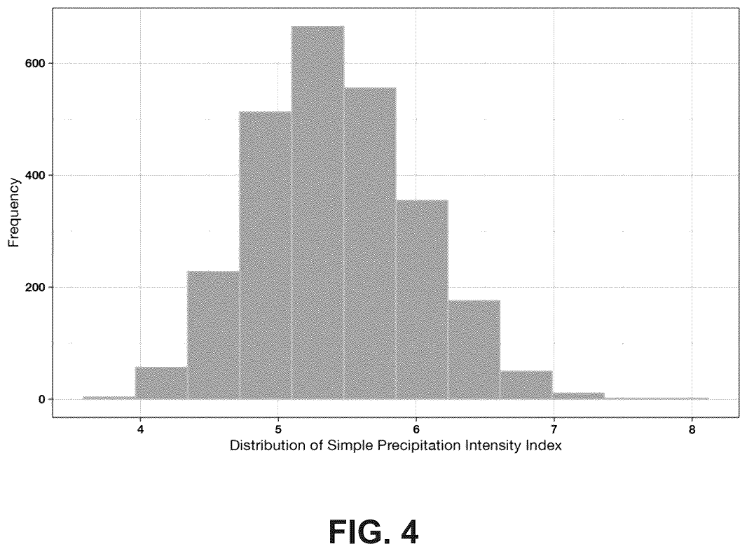

FIG. 4 illustrates an example distribution of Simple Precipitation Intensity Index for the City of London, United Kingdom, for the 2030 horizon, Stochastic View. System 100 can derive the Simple Precipitation Intensity Index by applying WCRP-defined calculations on CMIP6 variables of daily precipitation and the number of wet days. To address the projection biases, we weighted the distribution using climate weights. Further information on climate weights is provided herein.

Climate risk factors can be measured using various units. For example, sea level rise can be measured in metres whereas maximum daily wind speed can be measured in metres per second. To make different climate risk factors comparable, system 100 can scale the data distributions of climate projections. The scaling can be done by utilizing a normalization technique based on the 90th and 10th percentiles. The technique ensures the bulk of the distributions of climate projections overlap while avoiding the compression bias when dealing with skewed distributions.

To assure consistent scaling between horizons, every distribution of climate projections is scaled relative to the same baseline, the 2010 climatology. Numerically this means that 0 becomes the baseline for every climate risk factor.

$$Scaled ( {𝔣}_{i} ) = \frac{{𝔣}_{i} - historical ( {10}^{th} )}{historical ( {90}^{th} ) - historical ( {10}^{th} )} - c ( shift ) , where {𝔣}_{i} ∈ {D}_{i}$$

Dᵢ is the distribution of climate projection for i^{th} climate risk factor, f.

System 100 can determine polarity. After scaling the distributions of climate projections, system 100 can determine whether to invert the horizontal axis based on polarity. Polarity refers to whether an increase represents a negative or positive effect. Negative effect is interpreted as downside (risk potential) and positive effect is interpreted as upside (opportunity potential).

System 100 can assume that negative impact is associated with a worsening climate. Generally, extreme weather gives rise to economic risk. The assumption classifies any value less than the baseline of scaled distributions of climate projections as a risk, and any value greater than the baseline as an opportunity. A limitation is that some companies may net-benefit from climate change. For example, temperature rises may favour vineyards in the United Kingdom.

System 100 can derive Factor Risk Indicators. For example, system 100 describes the scaled distribution of climate projections for every factor using four statistics: (i) downside probability, (ii) upside probability, (iii) risk impact, and (iv) opportunity impact. The probability statistics measure the likelihood that a projection is to the right or left of 0 (i.e., the baseline). The impact statistics measure the magnitude of negative or positive impact associated with the risk factor.

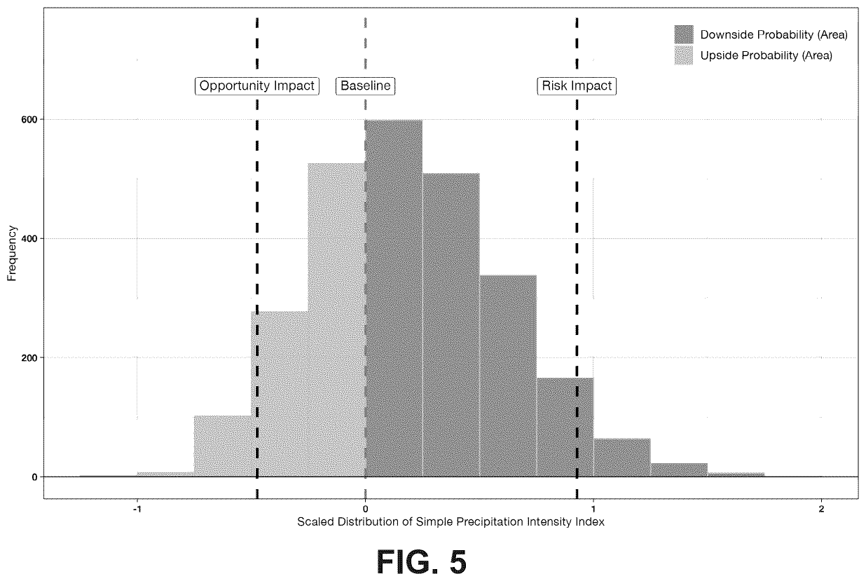

FIG. 5 shows an example graph of the distribution of Simple Precipitation Intensity Index Projections for the City of London, United Kingdom, for the 2030 horizon, Stochastic View. The projections are aligned by system 100 to Stochastic View scenario set.

From probability and impact variables, system 100 derives Factor Risk Indicators and Factor Opportunity Indicators. The following are examples of how system 100 can generate indicators.

$$Factor Risk Indicator = Downside Probability \times Risk Impact$$

$$Factor Opportunity Indicator = Upside Probability \times Opportunity Impact$$

While these statistics are distinct from the spanning set analysis, they illustrate the potential contribution individual risk factors may have on Climate Risk Indicators. The examples are helpful for comparing the materiality of individual risk factors. For example, system 100 can use them for ranking risk factors by degree of exposure (e.g., cyclone is the most impactful risk, followed by heatwave and extreme precipitation). Or, system 100 use them to quantify the extent to which one risk factor is more or less significant than another risk factor (e.g. cyclone is five times more impactful than cold snap).

In some embodiments, system 100 builds the spanning set. For example, the spanning set can be built by pairing the probability and impact values of each climate risk factor for each horizon. The branches represent all permutations of downside and upside for all risk factors in scope. As an illustrative example, system 100 can trace each branch to compute two metrics. First, the product of all probabilities (i.e., likelihood). Second, the sum of all impacts (e.g., total impact).

$${Likelihood}_{k} = {\prod }_{𝒿}^{n} p ( {𝔣}_{i} ) , where 𝒿 ∈ [ 1 , n ] , k ∈ [ 1 , {2}^{n} ]$$

fⱼ is the j^{th} climate risk factor along k^{th} branch in the spanning set, and
n is the maximum number of participating climate risk factors.

$$Total {Impact}_{k} = {\sum }_{𝒿}^{n} W ( {𝔣}_{i} ) , 𝒿 ∈ [ 1 , n ] , k ∈ [ 1 , {2}^{n} ]$$

fⱼ is the j^{th} climate risk factor along k^{t}h branch in the spanning set, and
W is either risk impact or opportunity impact, and
n is the maximum number of participating climate risk factors.

It is valid to consider all permutations across non-financial (physical) climate risk factors because they occur over 20-year climatologies and are assumed to be independent of one another (as illustrated below). For example, independent occurrences of both heatwave and cold snap can impact an asset over a 20-year climatology. Further information on assumptions is provided herein.

$$P ( {⋂}_{𝒾 = 1}^{m} {𝔣}_{𝒾𝒿} ) = {\prod }_{𝒾 = 1}^{m} P ( {𝔣}_{𝒾𝒿} ) , for ∀ m \leq n , ∀ m ∈ ( 1 \leq {j}_{1} < … < {j}_{m} \leq n )$$

fⱼ is the j^{th} climate risk factor along k^{th} branch in the spanning set, and
n is the maximum number of participating climate risk factors.

System 100 can derive multifactor risk exposure. Using the likelihood and total impact, system 100 computes a scenario intensity.

$$Scenario {Intensity}_{k} = {Likelihood}_{k} \times Total {Impact}_{k} , where k ∈ [ 1 , {2}^{n} ]$$

k is one branch in the spanning set, and
n is maximum number of participating climate risk factors.

The scenario intensities generated using the spanning set represent an expected value based on all possible combinations of risk and opportunity.

The following table is an example of Scenario Intensity for 11 Climate Risk Factors.

| Branch | Likelihood | Total Impact | Scenario Intensity |
|---|---|---|---|
| Branch 1 | 0.07852505 | 1.793981869 | 0.140872516 |
| Branch 2 | 0.034386787 | 0.679331166 | 0.023360016 |
| Branch 3 | 0.032607257 | 0.474381439 | 0.015468278 |
| Branch 4 | 0.074461349 | 0.640269265 | 0.047675313 |
| . . . | . . . | . . . | . . . |
| Branch 2045 | 0.085866555 | 1.360597932 | 0.116829857 |
| Branch 2046 | 0.037601694 | 2.475248635 | 0.093073542 |
| Branch 2047 | 0.081422928 | 2.514310536 | 0.204722526 |
| Branch 2048 | 0.035655792 | 3.628961239 | 0.129393487 |

A Climate Risk Indicator can be calculated by dividing the count of scenario intensities less than 0 (i.e., downside) over the count of scenario intensities more than 0 (i.e., upside).

$$Climate Risk Indicator = \frac{{\sum }_{k = 1}^{{2}^{n}} [ Scenario {Intensity}_{k} > 0 ]}{{\sum }_{k = 1}^{{2}^{n}} [ Scenario {Intensity}_{k} > 0 ]}$$

k is one branch in the spanning set, and
n is maximum number of participating climate risk factors.

Climate Risk Indicators represent joint density probability functions. They are composed of both the likelihood (i.e., likelihood value) and impact of a scenario (i.e., total impact value). Therefore, a Climate Risk Indicator illustrates the exposure of an asset to risk potential relative to opportunity potential.

Besides Climate Risk Indicator, system 100 can also generate a downside risk indicator. This is done by dividing the count of scenario intensities less than 0 (i.e., downside) over the count of all branches.

$$Downside Climate Risk = \frac{{\sum }_{k = 1}^{{2}^{n}} [ Scenario {Intensity}_{k} < 0 ]}{{2}^{n}}$$

k is one branch in the spanning set, and
n is maximum number of participating climate risk factors.

A Downside Climate Risk illustrates the probability of an asset to risk potential.

System 100 can transform multifactor risk exposure. System 100 can express multifactor risk indicators using alpha-numeric values. The following table is of example transformations to alphanumeric schemes.

| Climate Risk Indicator | Alphanumeric Scheme |
|---|---|
| 0.00 to 0.20 | U5 |
| 0.20 to <0.25 | U4 |
| 0.25 to <0.33 | U3 |
| 0.33 to <0.66 | U2 |
| 0.66 to <1.00 | U1 |
| 1.00 to <1.5 | D1 |
| 1.5 to <2.5 | D2 |
| 2.5 to <3.5 | D3 |
| 3.5 to <4.5 | D4 |
| >5.00 | D5 |

As noted herein, the letter ‘D’, represents downside while ‘U’, represents upside. The numbers express the likelihood of risk potential or upside potential. For example, D4 means that the downside risk of climate stress is four times the upside potential. Conversely, U4 means that the upside risk of climate stress is four times the downside potential.

System 100 can aggregate multifactor risk exposure. The individual assets can be given the same weight during aggregation. For company exposure, the assets with inactive status can be dropped from the calculation.

### Material Risk

In some embodiments, climate risk can be categorized as material when the Climate Risk Indicator is 1.5 (D2) or higher. In other words, when risk potential is two times or more than the upside potential. Meanwhile, Factor Risk Indicators are categorized as material when they exceed the 75th percentile of all Factor Risk Indicators (across pathways, horizons, and locations).

It is possible that there is more than one material factor per asset for a specific pathway, horizon, and location. For example, heatwave and extreme precipitation are material factors for the Bank Station in the City of London, under the No Additional Policies Scenario, in 2050. It is also possible that an asset has a material Climate Risk Indicator without any material factors or visa versa.

By analogy, there may be a football club that is strong as a collective but does not have any star players. Or, there may be a football club that is weak as a collective with a star striker and star goalkeeper.

### Scenario Analysis

In some embodiments, system 100 can implement scenario analysis. System 100 can provide three scenario sets in addition to fully stochastic analytics, the Paris Aligned Scenarios, National Commitment Scenarios, and No Additional Policies Scenarios. To compute analytics for each scenario set, system 100 can apply the same methodology only include projections that align to the GMT ranges.

### Risk Factors

In some embodiments, system 100 can model risk factors. For example, system 100 can include 11 physical risk factors in the spanning set. The following table shows an example wherein includes 11 physical risk factors in the spanning set.

| Climate Risk | Climate Risk | | | |
|---|---|---|---|---|
| Factor | Index | Definition | Unit | Polarity |
| Carbon Price | Carbon Price | The price of carbon | USD | Downside |
| Electricity Price | Electricity Price | The price of electricity | USD | Downside |
| Precipitation | Simple | Annual average | Millimetres per | Downside |
| Pattern Changes | Precipitation | precipitation for days | day (mm/day) | |
| | Intensity Index | with daily precipitation | | |
| | | over 1 mm/day. | | |
| Sea Level Rise | Coastal Flood | Projected inundation depth | Metres (m) | Downside |
| | | from coastal floods | | |
| | | (Subsidence included | | |
| | | in projection). | | |
| Ice and Permafrost | Daily Freeze | Number of days when the | No. of Days | Downside |
| Melt | Thaw Cycles | air temperature fluctuates | | |
| | | between freezing and | | |
| | | non-freezing temperatures | | |
| | | (i.e., when maximum daily | | |
| | | temperature is above 0° C. | | |
| | | and minimum daily temperature | | |
| | | is below 0° C.). | | |
| Heatwave | Heat Wave Index | Number of days that are | No. of Days | Downside |
| | | part of a heatwave, defined | | |
| | | as five or more consecutive | | |
| | | days over 25.0° C. | | |
| Cold Snap | Frost Days | Number of days with | No. of Days | Downside |
| | | minimum daily temperature | | |
| | | below 0° C. | | |
| Drought | Maximum | Maximum number of | No. of Days | Downside |
| | Consecutive Dry | consecutive days with daily | | |
| | Days | precipitation below 1 mm/day. | | |
| Wildfire | Fire Weather Index | The Fire Weather Index | NA | Downside |
| | | (FWI) is a numeric rating of | | |
| | | fire intensity. It is based on | | |
| | | the ISI and the BUI, and is | | |
| | | used as a general index of | | |
| | | fire danger. | | |
| Extreme | Maximum 1-Day | Maximum 1-day total | Millimetres per | Downside |
| Precipitation | Total Precipitation | precipitation. | Day (mm/day) | |
| Extreme | Maximum Daily | Maximum of daily | Metres per | Downside |
| Wind | Maximum | maximum surface wind | Second (m/s) | |
| | Wind Speed | speed. | | |
| Cyclone | Cyclone | Maximum wind speed. | Metres per | Downside |
| | | | Second (m/s) | |
| Flood | Riverine Flood | Projected inundation depth | Metres (m) | Downside |
| | | from riverine floods. | | |

### Assumptions

Example assumptions relate to wildfire. Wildfire is measured using the fire weather index (“FWI”), which is derived from other risk factors, such as wind speed and temperature. While it is possible to calculate the FWI for every location on Earth, it is not possible for occurrences of wildfire in urban settings. Therefore, in some embodiments, system 100 identifies areas with major vegetation using Copernicus Land Cover Classification to determine whether wildfire is an appropriate risk factor. Locations are considered relevant if they are within the vegetation area or less than 500 meters away.

Example assumptions relate to independence of risk factors. The spanning set assumes each risk factor is independent. While risk factors are likely to be correlated in the immediate term, they are not likely to be correlated over the 20-year climatology periods that system 100 can compute risk indicators for. Additionally, as the climate becomes more extreme and volatile, the correlations diverge from their historical norms. Over 20-year climatology, the risk profile of climate risk factors is not temporally aligned. Extreme events occur randomly and in an unpredictable manner making a correlation between factors in the long-term assessment of risk negligible. For example, during 20-year climatology, drought and flood can occur at the same location, but not at the same time. The spanning set approach accounts for all permutations of the climate risk factors.

### Validation

System 100 can validate output results.

For example, system 100 can validate output results using empirical tests. System 100 can compute tests on our methodology by measuring whether the distributions of climate projections would have captured near-term extreme events. For example, in 2022 there were 307 record-breaking occurrences of maximum daily temperature around the world. The data, which were generated prior to 2020, captured 90.1% of these occurrences (279 of 307) during testing by system 100.

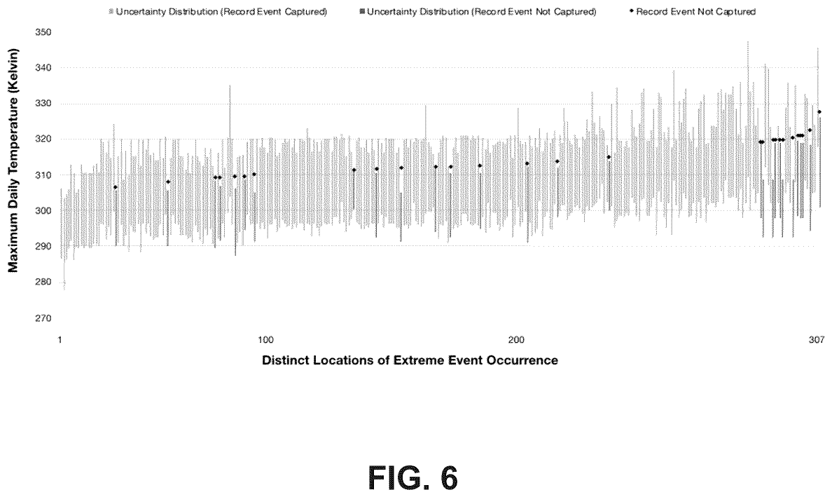

FIG. 6 illustrates results from example empirical validation testing of maximum daily temperatures in 2022. The data, which was projected before 2020, captured 90.1% of occurrences of record-breaking maximum daily temperature around the world in 2022. Each point on the x-axis represents a distinct location where an extreme weather event occurred.

Similarly, in 2022 there were 47 record-breaking occurrences of minimum daily temperature around the world. The data, which were generated prior to 2020, captured 89.4% of these occurrences (42 of 47).

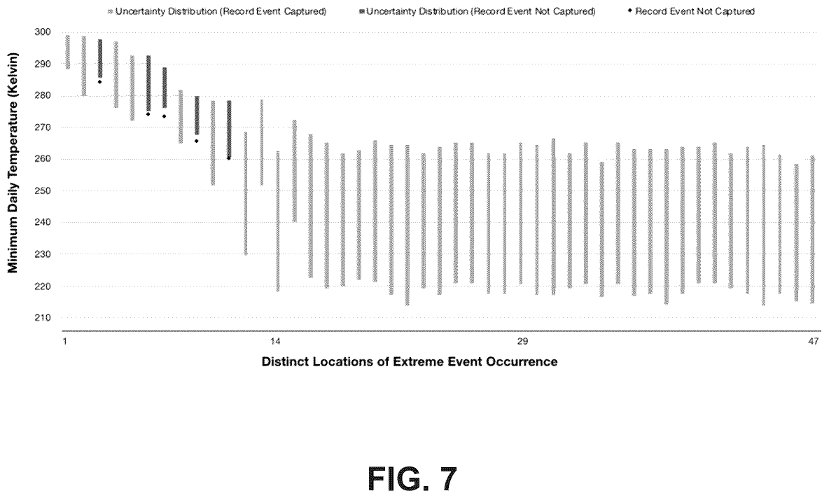

FIG. 7 illustrates results from example empirical validation testing of minimum daily temperatures in 2022. The data, which was projected before 2020, captured 89.4% of occurrences of record-breaking minimum daily temperature around the world in 2022. Each point on the x-axis represents a distinct location where an extreme weather event occurred.

These empirical tests are important because if the underlying distribution of climate projections is robust, so too will the outputs of system's 100 multifactor scenario analyses. Moreover, the tests highlight the uncertainty and volatility of weather projections. For the missed occurrences, the projections of climate models underestimated the severity of extreme events, accentuating the shift in the underlying distributions.

For example, system 100 can validate output results using automated reviews.

Domain experts can conduct a rigorous data driven review of model outputs. This involved various robustness automated checks. For example, testing can ensure that the GMT and Downside Climate Risk values across all horizons are positively correlated. During testing, system 100 observed that increases in GMT are associated with increases in Downside Climate Risk.

The summary statistics are consistently intuitive across all scenario sets. For example, oftentimes the Paris Aligned Scenarios have a lower risk than the No Additional Policies Scenarios. Additionally, risk tends to increase as horizons progress.

Nevertheless, it is important to not expect that the results will always illustrate these trends. Climate risk is volatile. To ensure the data quality, despite the automated tests, system 100 can conduct a review for every outliner point. In the process, system 100 differentiates the edge and corner cases from the errors in the calculations. The checks assure the results are purely data-driven and rigorous.

An example of an edge case is an asset where Downside Climate Risk mostly decreases. In this example, the highest Downside Climate Risk is at the 2030 horizon under National Commitment Scenarios and mostly decreases across horizons. To understand the reason behind the risk fluctuation, system 100 can analyze the underlying factor risk indicators.

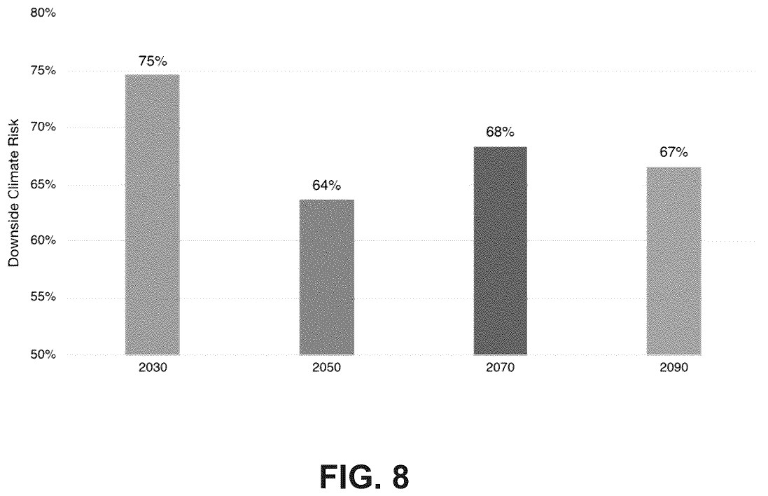

FIG. 8 shows an example graph of downside climate risk across horizons. Overall, the location's downside climate risk has a non-linear pattern. As horizons progress, the overall risk decreases. The highest risk value is at the 2030 horizon, followed by the 2070 horizon.

The risk surface of the location heavily depends on the relative climate risk factors and respective magnitude and probability values. Importantly, the increase in risk does not necessarily imply a decrease in opportunity. As horizons progress, the distribution of climate projections can either shrink, expand, skew towards opportunity (i.e., left), or skew towards risk (i.e., right). The spanning set embraces both the potential of risk (i.e., downside) and the potential of opportunity (i.e., upside) for every factor. For this location, the drastic decrease in factor risk indicator for extreme wind in 2030-2050 is accompanied by an increase in factor opportunity value. However, for the 2070-2090 horizons, the risk and opportunity indicators increase together. Similarly, both factor risk and opportunity indicators mainly increase across horizons for drought. The permutations of similar trends across factors leads to fluctuations in the overall Downside Climate Risk values for the location.

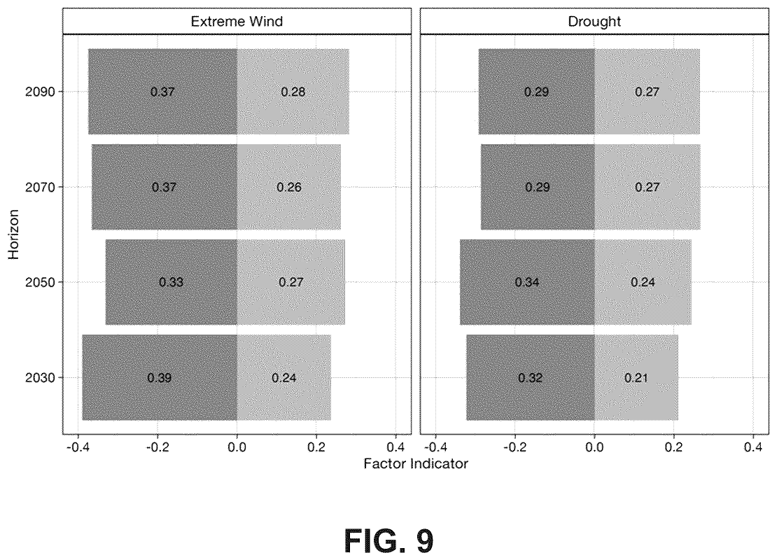

FIG. 9 shows an example graph of factor risk and opportunity indicators across horizons, national commitment scenarios. From the 2030-2050 period, the extreme wind factor risk indicator drastically decreases, indicating favourable conditions. Similarly, during 2050-2070, the risk from drought decreases affecting the overall risk surface of the location. For both factors, the opportunity values mostly increase irrespective of risk indicators as horizons progress.

Example Use Cases

System 100 can apply to different use cases. Examples include (i) strategy and investment decision making and (ii) reporting and disclosures.

To illustrate how system 100 data generates insight for strategic planning purposes, system 100 can analyze the climate risk exposure of an example global mining company (the “Company”).

The Company currently owns or manages 50 manufacturing plants (also referred to as “assets” herein) in over 12 countries. System 100 can observe that the Company overall (i.e., across all mining sites in all countries) is highly exposed to climate change—with Downside Climate Risk increasing from 74% in 2030 to 79% in 2090. This ‘big picture’ result can help investors situate the company within its peer group (e.g., similarly sized companies in the mining sector) from a climate risk perspective, as well as inform security selection and portfolio optimization modelling and decisions.

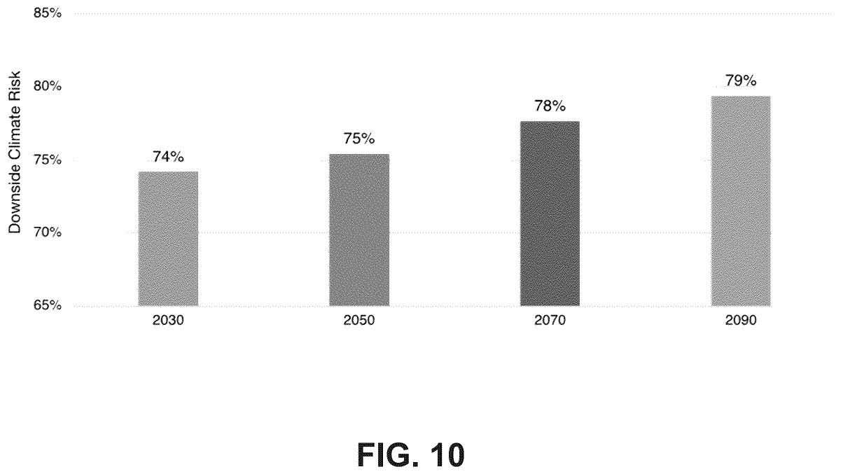

FIG. 10 is an example graph showing Downside Climate Risk at Global Level, 2030-2090. Overall (i.e., across all mining sites in all countries), the Company's Downside Climate Risk is estimated at 74% in 2030, 75% in 2040, 78% in 2070, and 79% in 2050.

The Company's climate risk exposure varies significantly across the countries it operates in. For example, Canada—one of the Company's largest markets of mining sites-ranks among the riskiest countries from a climate perspective. These results help stakeholders identify which regions drive climate risk.

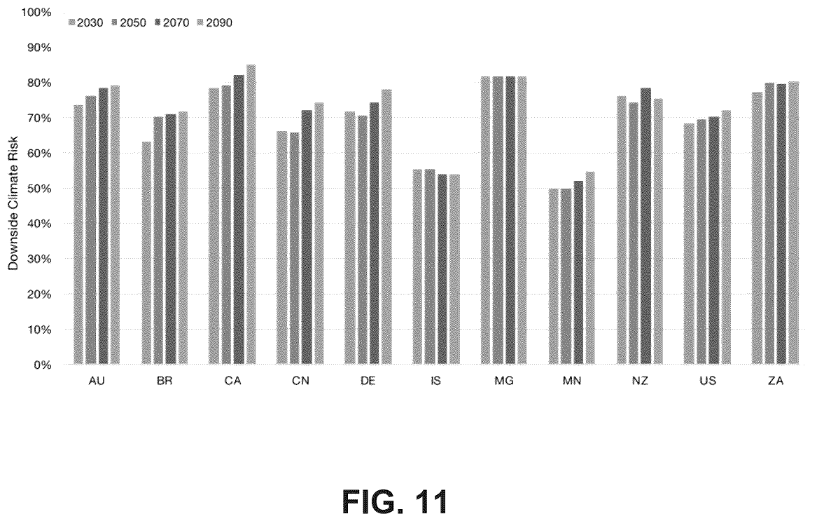

FIG. 11 is an example graph showing Downside Climate Risk at Country Level, 2030-2090. The Company's Downside Climate Risk varies significantly across its countries of operation. Canada, one of the Company's largest markets of mining sites, ranks amongst the riskiest countries from a climate perspective.

Looking at how climate risk exposure differs across individual assets in Canada, system 100 can find that mining sites in the Quebec province are relatively more exposed to climate change. This view helps stakeholders pinpoint specific assets for further review.

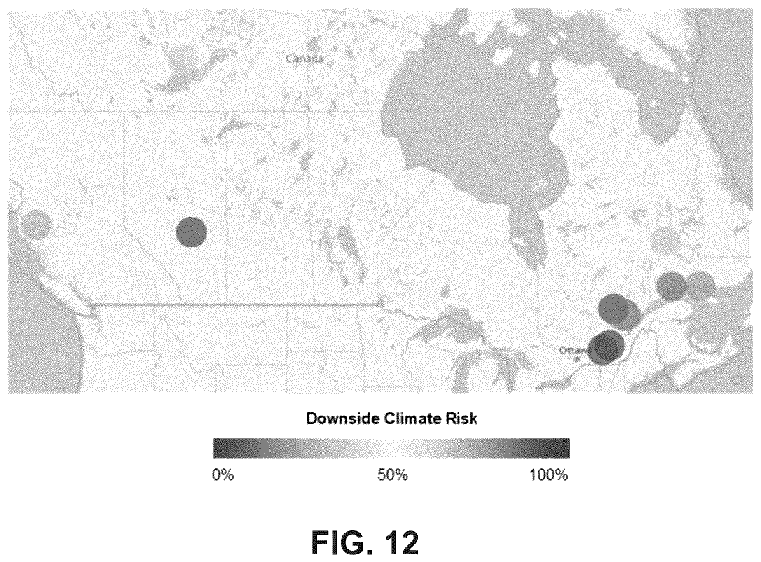

FIG. 12 is an example interface showing a Map View of Downside Climate Risk for Individual manufacturing assets in Canada, 2050. In Quebec, the Company's manufacturing sites are relatively more exposed to climate change (relative to the other provinces). Note that the size of the points is not proportional to the number of assets. The locations highlight the region of assets for visual clarity.

For instance, the Company's aluminum manufacturing site in Saguenay-Lac-Saint-Jean (a region in the Province of Quebec) is highly exposed to climate change—with Downside Climate Risk at 98% in 2050. System 100 can find that the most important climate risk factor for this asset in 2050 is Riverine Flood, followed by Heatwave and Extreme Precipitation. This form of analysis can help stakeholders prepare for, and adapt to, future climate change. For example, in the case of mining sites, operators can increase the mine pit area and adjust water management strategies to mitigate the risk of uncontrolled flooding.

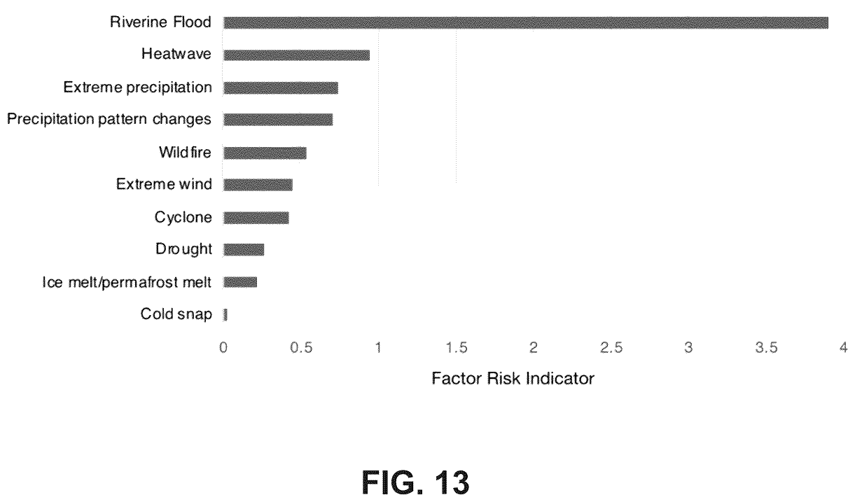

FIG. 13 is an example graph showing Climate Risk Drivers for Single Asset (Manufacturing Site in Saguenay-Lac-Saint-Jean), 2050. In 2050, the top three climate risk drivers for the Company's manufacturing site in Saguenay-Lac-Saint-Jean are Riverine Flood, Heatwave, and Extreme Precipitation.

As another example use case, system 100 can apply to reporting and disclosures applications.

To illustrate how system's 100 data and analytics can be used to fulfill climate-related disclosure requirements, system 100 can consider the TCFD's guidance regarding physical risk: specifically, the “disclosure of the amount or extent of an organization's assets or business activities vulnerable to material climate-related physical risks.” The TCFD recommends that physical risks be measured under different climate scenarios (including a 2° C. or lower scenario), for different time horizons (with 2030 and 2050 noted as key target dates for addressing climate change), and by sector and/or geography as appropriate.

Following this guidance, system 100 can analyze the climate risk exposure of a model portfolio that comprised four companies in the technology sector. Each company owns or manages several assets, which are classified into four categories (i.e., asset types): (i) administration, (ii) distribution, (iii) manufacturing, and (iv) research and development (R&D).

System 100 can analyze the downside climate risk of the entire portfolio (i.e., aggregated across all assets owned or managed by the four companies) under three scenario sets (Paris Aligned Scenarios, National Commitment Scenarios, and No Additional Policies Scenarios) and for two horizons (2030 and 2050). As expected, climate risk exposure is least pronounced under the Paris Aligned Scenarios.

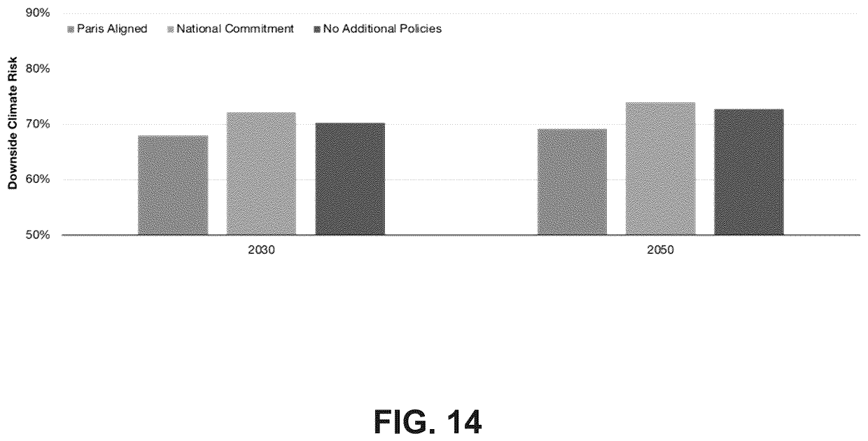

FIG. 14 is an example graph showing Downside Climate Risk of Model Portfolio, 2030 and 2050, All Scenario Sets. The downside climate risk of the model portfolio (i.e., aggregated across all assets owned or managed by the four companies) in 2030 and 2050 is 68% and 69%, respectively, under the Paris Aligned Scenarios—lower than that under the National Commitment Scenarios and No Additional Policies Scenarios.

System 100 can analyze all companies within the model portfolio and can determine that Company D has the highest downside climate risk across nearly all scenario sets and horizons. This can prompt a further examination of the drivers of Company D's climate risk exposure.

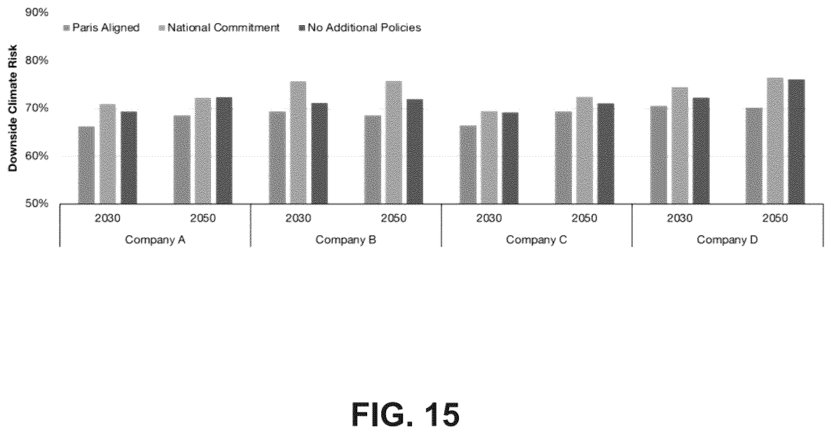

FIG. 15 is an example graph showing Downside Climate Risk by Company in Model Portfolio, 2030 and 2050, All Scenario Sets. In 2030, relative to the other companies, Company D has the highest downside climate risk under the Paris Aligned Scenarios and No Additional Policies Scenarios. In 2050, Company D has the highest downside climate risk under all three scenario sets. Moreover, under the Paris Aligned Scenarios, the downside climate risk of Company B and Company D decreases from 2030 to 2050—outcomes that reflect a gradual reduction in climate risk in parts of the world if the Paris Agreement is met.

Looking at the Paris Aligned Scenarios (as an example) Company D is primarily exposed to cyclone, extreme precipitation, and heatwave. By 2050, 65% of the company's assets are materially exposed to cyclone, 25% to extreme precipitation, and 25% to heatwave. Cold snap, drought, extreme wind, and ice melt/permafrost melt are not considered material risks for Company D.

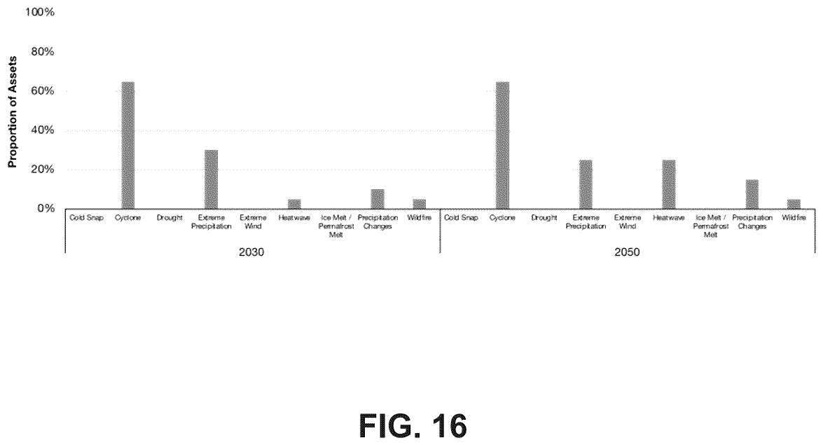

FIG. 16 is an example graph showing Primary Risk Drivers for Company D, 2030 and 2050, Paris Aligned Scenarios. By 2050, 65% of Company D's assets are materially exposed to cyclone, 25% to extreme precipitation, and 25% to heatwave. Company D is not materially exposed to cold snap, drought, extreme wind, and ice melt/permafrost melt.

A further examination of Company D's climate risk exposure by geography and asset type by system 100 revealed that (i) its assets in the United States are more exposed than those in other geographies and (ii) its manufacturing assets are more exposed than other asset type.

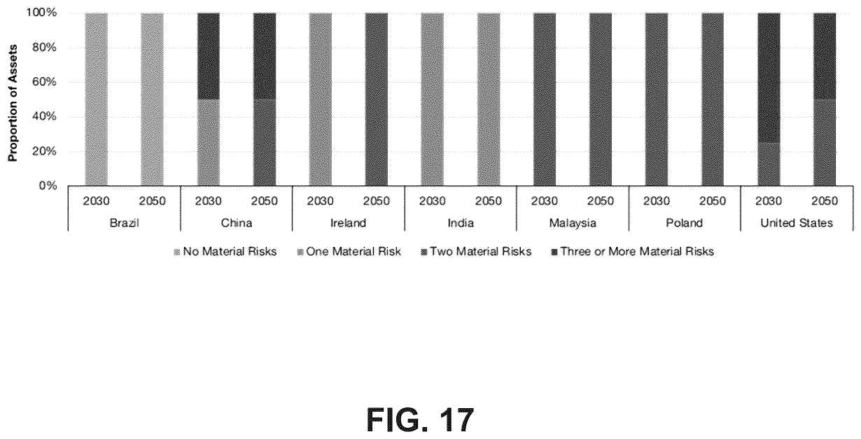

FIG. 17 is an example graph showing Material Risks by Geography for Company D, 2030 and 2050, Paris Aligned Scenarios. In 2030 and 2050, 50% or more of Company D's assets in the United States are exposed to three or more material risks.

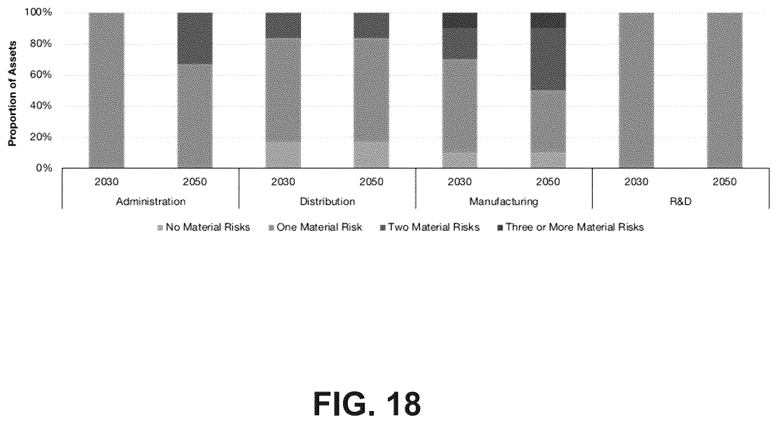

FIG. 18 is an example graph showing Material Risks by Asset Type for Company D, 2030 and 2050, Paris Aligned Scenarios. By 2050, 40% of Company D's manufacturing assets are exposed to two material risks and 10% are exposed to three or more material risks.

Company D has three manufacturing assets in the United States. Looking at the downside climate risk of each asset, system 100 can identify that the one in Massachusetts is relatively more exposed to climate change—with a downside climate risk of 79% in 2030 and 80% in 2050.

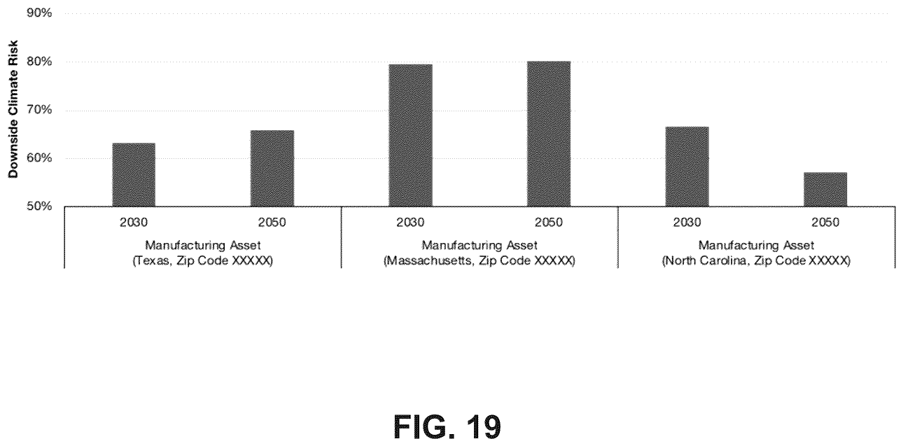

FIG. 19 is an example graph showing Downside Climate Risk of Company D's Manufacturing Assets in the United States, 2030 and 2050, Paris Aligned Scenarios. The downside climate risk of Company D's manufacturing asset in Massachusetts is 79% in 2030 and 80% in 2050—higher than that of its other two manufacturing assets in the United States.

In 2050, Company D's manufacturing asset in Massachusetts is exposed to four material risks. Factor Risk Indicators reveal that it is most exposed to cyclone, followed by heatwave, precipitation changes, and extreme precipitation.

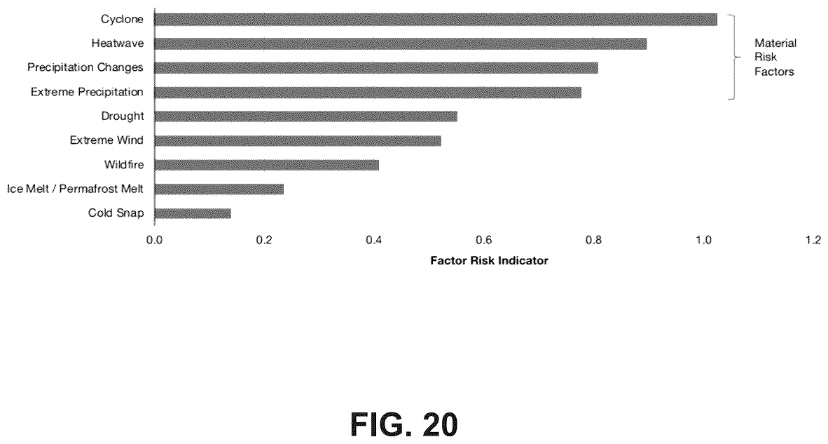

FIG. 20 is an example graph showing Factor Risk Indicators for Company D's Manufacturing Asset in Massachusetts, 2050, Paris Aligned Scenarios. In 2050, Company D's manufacturing asset in Massachusetts is materially exposed to four risk factors: cyclone, heatwave, precipitation changes, and extreme precipitation. Cyclone is the most pronounced risk factor.

By analyzing the Factor Risk Indicators for every asset owned or managed by every company in the model portfolio, system 100 can assess the primary climate risk drivers for the entire portfolio by scenario set and time horizon. For example, by 2050, under the No Additional Policies Scenarios, 88% of all assets in the purview of the model portfolio are materially exposed to heatwave, 44% to cyclone, and 42% to extreme precipitation. Cold snap and ice melt/permafrost melt are not considered material risks for the model portfolio.

Factor Risk Indicators, which are derived from probability and impact variables, are used by system 100 to measure the relative contribution of individual risk factors to Climate Risk Indicators. For example, Factor Risk Indicators of 1.02 for cyclone, 0.90 for heatwave, and 0.81 for precipitation changes (results for Company D's manufacturing asset in Massachusetts, as shown in FIG. 19) indicate that the asset is more exposed to cyclone than it is to heatwave and precipitation changes, and more exposed to heatwave than it is to precipitation changes.

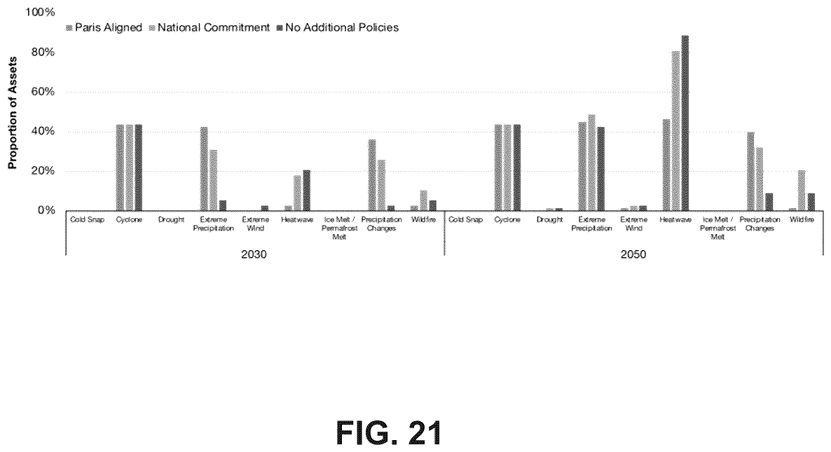

FIG. 21 is an example graph showing Primary Risk Drivers for Model Portfolio, 2030 and 2050, All Scenario Sets. There are differences in the model portfolio's material risks across the scenario sets. For example, by 2050, 88% of all assets associated with the model portfolio are materially exposed to heatwave under the No Additional Policies Scenarios, whereas this value is 46% under the Paris Aligned Scenarios.

This example illustrates how system 100 output metrics are useful for generating regulatory and voluntary disclosures, such as TCFD-aligned disclosures. The data reveals climate risk from various perspectives: for instance, at the portfolio, company, geography, sector, asset type, and asset levels—as well as at individual risk factor and multifactor levels. All analytics are made available under various scenarios. A full quantitative diagnosis of climate risk is made possible.

### Data Governance and Controls

System 100 provides data integrity. System 100 can maintain a very high level of quality assurance that involves a rigorous process of validating data sources. Data sources must adhere to a minimum set of integrity requirements. This can include publication in a peer-reviewed journal (e.g., Nature Climate Science), intergovernmental agency (e.g., IPCC), or national government agency (e.g., NOAA). System 100 can also accept data published by an accredited university (e.g., Oxford University). To accept their data, all sources must provide (i) a definition of variables, units, spatial and temporal extents, (ii) a journal reference or attribution to the original data producer, and (iii) a license defining its copyright status. System 100 records and stores all data access and import dates, along with source attributes. System 100 records and stores all relevant data licenses.

System 100 can implement climate data and metadata validation. System 100 can ensure that data is ingested, processed, and utilized uniformly and traceably. Every data pipeline is monitored and version controlled. Rigorous variable-level checks are applied to every dataset before they are ingested to our platform. System's 100 approach to handling metadata can be based on the Climate and Forecast Metadata Convention. File names, spatial indexes, and temporal frequencies are standardized across all datasets.

System 100 provides alignment of data (e.g. distributed data sets from different input sources) so that it can be processed by processor 120 in a consistent way.

System 100 has a multi-factor scenario generator 150 that automatically generates scenarios. To obtain consistency across markets, and sectors within markets, the system 100 can use multi-factor scenario generator 150 to generate spanning sets. The server 100 uses the distributions as inputs and the multi-factor scenario generator 150 produces multifactor scenarios as outputs. In this way, the system 100 uses the same methodology across and within markets for multifactor stress testing.

System 100 uses the scenario generator 150 to generate multifactor scenarios on combinations of the climate risk factors for each horizon in the future that is of interest. The end result has interesting properties: the best and worst scenario for each factor is contained in the scenario set. This can be referred to as a spanning set of stress scenarios over time.

The hardware processor 120 can compute risk factor distributions using simulations. The processor 120 can generate forward looking uncertainty distributions for the risk factors, in each geography, at each time horizon. The models and their underlying parameters are updated continuously as new data becomes available and new scenarios are derived.

System 100 connects to a user device 170 with a hardware processor having a client application to transmit queries to the hardware processor 120, and an interface 180 to generate visual elements at least in part corresponding to the risk factor indicators received in response to the queries. System 100 can respond to requests from interface 180 for different use cases and risk factors. System 100 processes data from the different sources to generate input for the risk factors and models. The user device 170 has a hardware processor having an interface 180 to provide visual elements by accessing the multifactor scenario sets. The user device 170 can access the scenario data from its non-transitory memory by a processor executing code instructions. The interface 180 updates in real-time in response to computations and data at system 100.

System 100 can use API gateway 140 to exchange data and interact with different devices 170 and data sources 190. The server can receive input data from data sources 190 to populate the memory 110 storing computer risk factors, indicators, and the scenario sets. In some embodiments, the hardware system 100 continuously populates the data in memory 110.

System 100 can classify companies and physical assets based on NAICS. A company can be assigned a primary code based on its main line of business, and if applicable, a secondary company code. A physical asset can be assigned a primary code based on its asset name or description.

System 100 can generate an asset taxonomy and an asset classification model.

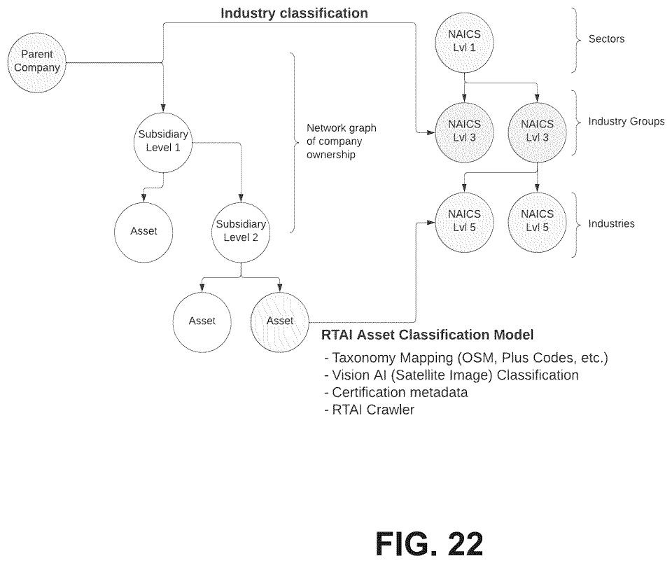

FIG. 22 shows an example asset taxonomy that system 100 can generate for an asset of a company as part of the process of generating climate risk indicators. The asset classification model can include a taxonomy mapping, machine vision classification (e.g. satellite images), and certification metadata, for example.

System 100 can identify material assets for a company. System 100 can consider various factors in determining whether a physical asset is material. For example, system 100 can consider industry alignment (e.g. using two digit industry codes), geospatial data, and segmented company data.

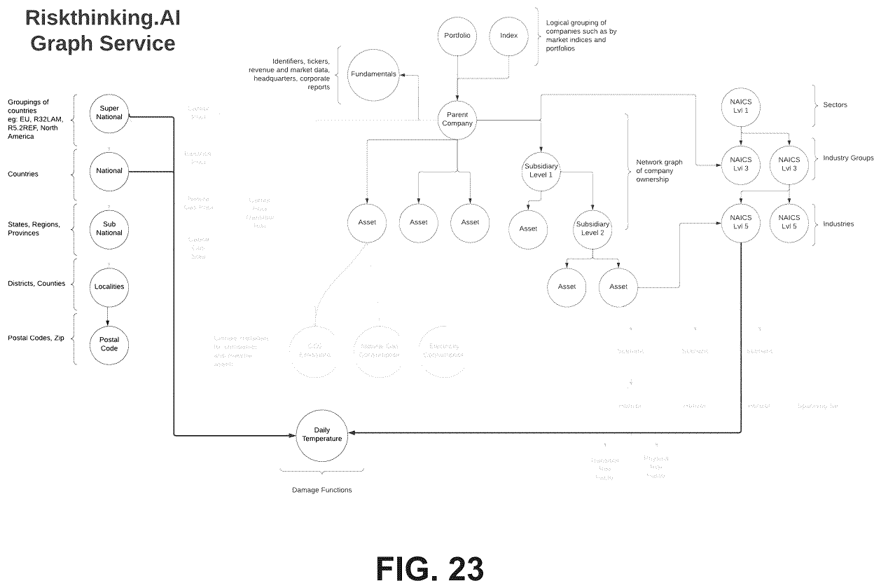

System 100 can consider impact functions of an asset based on industry and region. The impact can vary from extreme climate events and gradual climate changes. FIG. 23 shows an example graph of impact functions for assets.

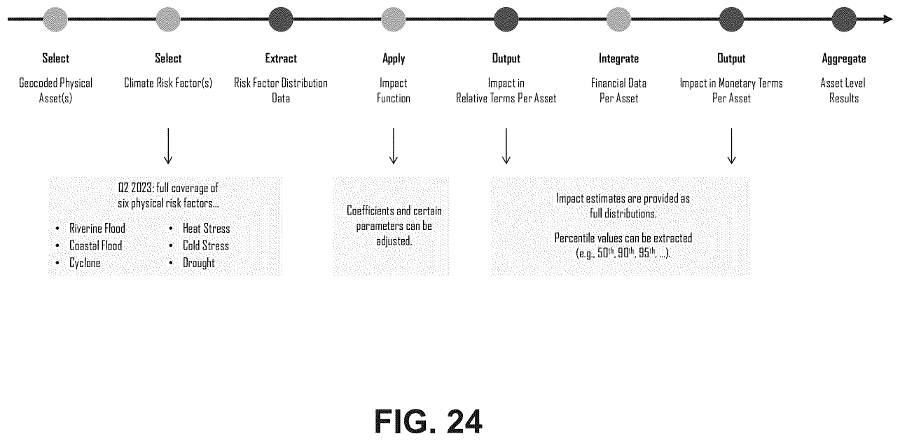

FIG. 24 shows an example data processing pipeline of operations by system 100 to process data.

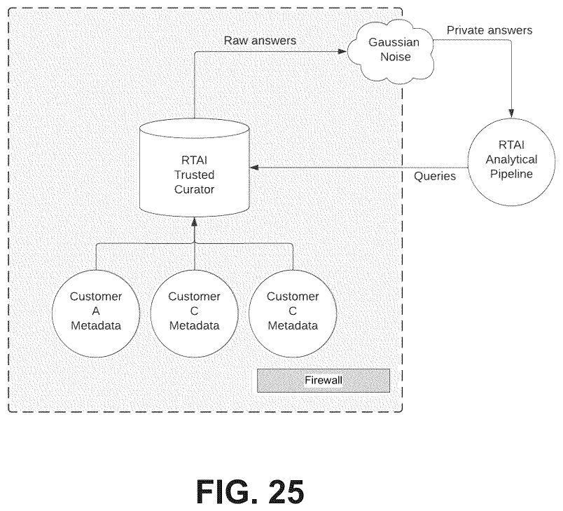

FIG. 25 shows example data storage of system 100. Sensitive data stays within a customer firewall with queries from system 100 fielded by a Trusted Curator service. A customer (e.g. user device 170) can control the amount of gaussian noise introduced to ensure answers from the service are private. System 100 can manage customer data privacy needs using a variable privacy budget. Models can start as statistical and overtime become machine learning workflows by employing a differential privacy stochastic gradient descent (DP-SGD) techniques.

System 100 can generate visual elements for visualizations at interface 180.

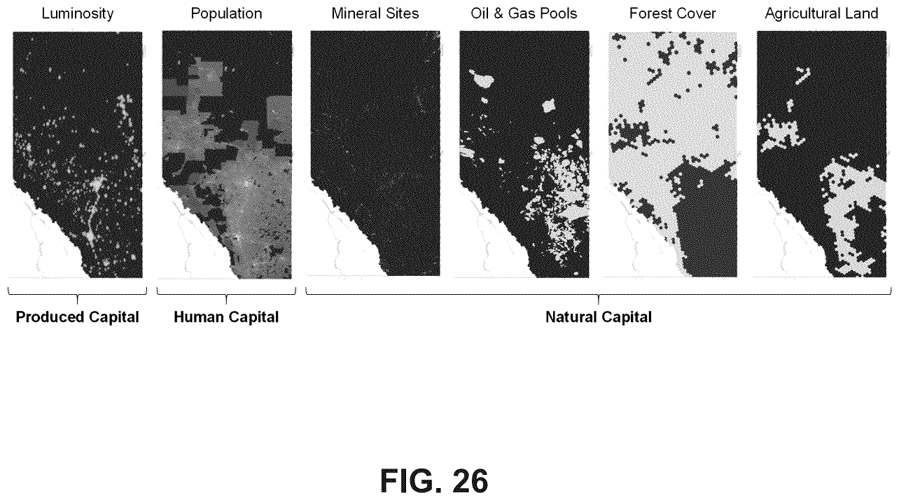

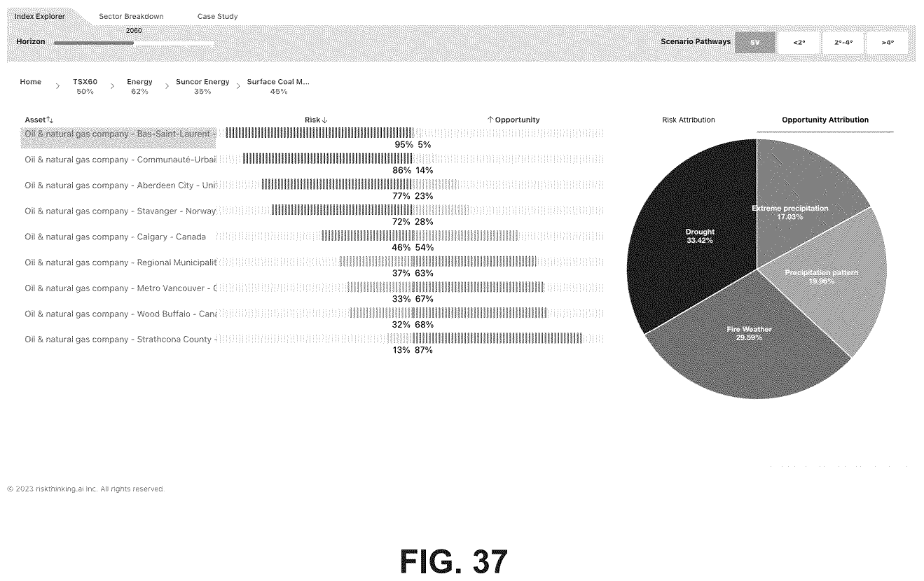

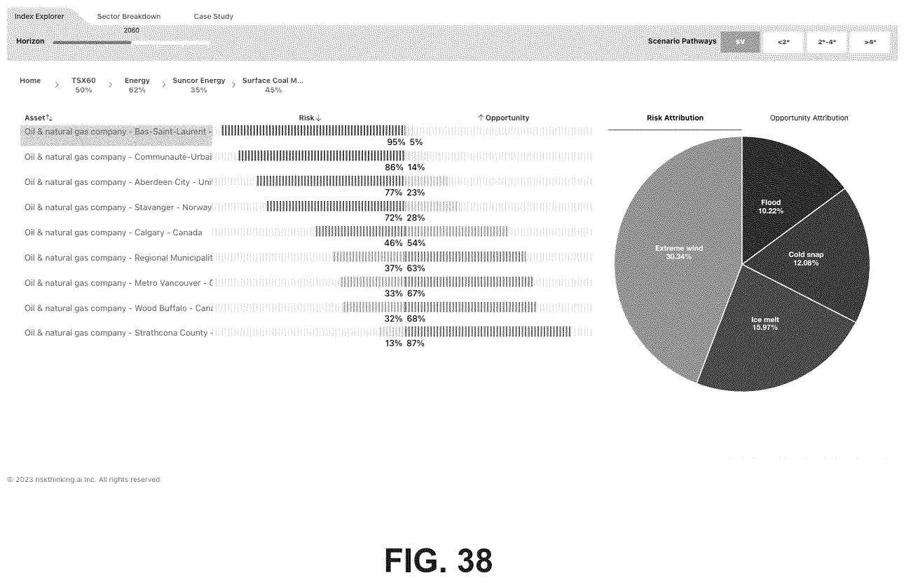

FIGS. 26 to 38 show different example visualizations at interface 180.

As noted herein, system 100 can connect to a user device 170 with a hardware processor having a client application to transmit input data to the API gateway 140. The user device 170 has an interface 180 to generate visual elements at least in part corresponding to the portion of the multifactor climate risk indicators received in response to the input data. The interface 170 receives input that can be used by system 100 to generate visual output. The interface 170 can receive input to navigate the financial impact of climate risk into the future for a physical asset of an entity, for any climate pathway, for any time period. The interface 170 receives updated output from the system 100 to visually navigate the financial impact of climate risk into the future for a physical asset of an entity, for any climate pathway, for any time period.

The interface 180 can display visualization of data including location data, climatology data, risk factor data for different types of risk factors, and distributions of climate risk projections. The different types of risk factors can include climate risk factors, policy risk factors, and social risk factors. The risk factors can be made up of risk indexes. The risk indexes include the climate risk indexes, policy risk indexes, and social risk indexes. The climate risk indexes comprise transition risk indexes and physical risk indexes;

The interface 180 can display visualizations of the distributions of climate risk projections, including, for each climate risk factor, forward-looking distributions of projected values for the climate risk factor for a given location and future climatology projection.

The interface 180 can display visualizations of, for each climate risk factor, a risk impact and an opportunity impact. The risk impact indicates a magnitude of negative impact a location is set to experience relative to a baseline, and the opportunity impact indicates a magnitude of positive impact the location is set to experience relative to the baseline.

The interface 180 can display visualizations of, for each climate risk factor, an upside probability and a downside probability. The downside probability measures a likelihood that a projection is inside a risk area relative to the baseline and the upside probability measures a likelihood that the projection is inside an opportunity area relative to the baseline.

The interface 180 can display visualizations of multifactor scenario sets that represent an effect that a plurality of climate risk factors have on a physical asset over a time horizon. The multifactor scenario sets account for permutations of the plurality of climate risk factors over the time horizon. The multifactor scenario sets form a spanning set as a binary scenario tree of nodes, each branch of the tree representing a possible combination of climate risk factors and the upside probability and the downside probability for the climate risk factors, the spanning set having edges connecting the nodes to create climate pathways. The interface 180 can display the spanning set to enable analysis of different types of risk indexes independently or as a combination.

The interface 180 can display visualizations of multifactor climate risk indicators and the multifactor scenario sets. The climate risk indicators include factor risk indicators, factor opportunity indicators, and climate risk indicators. A factor risk indicator measures a location's degree of risk exposure to a climate risk factor, and a factor opportunity indicator measures the location's degree of opportunity exposure to the climate risk factor. A physical climate risk indicator measures the exposure of an entity or physical asset to a climate risk potential relative to an opportunity potential. The physical climate risk indicators provide downside climate risk and upside climate risk of a physical asset or a group of physical assets, the downside risk defined as an impact weighted downside probability on the asset or the group of assets and the upside risk defined as an impact weighted upside probability on the asset or the group of assets. The climate risk indicators include physical climate risk indicators and transition (economic) climate risk indicators.

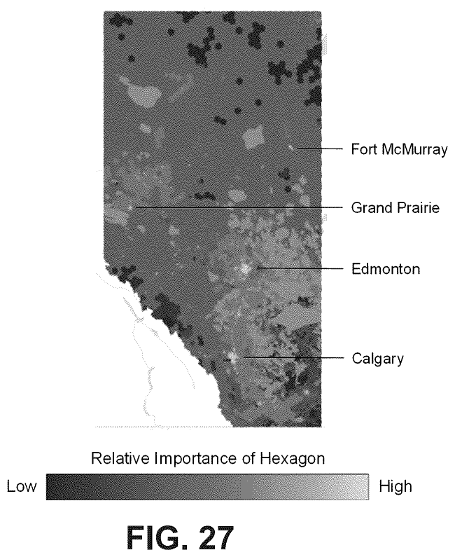

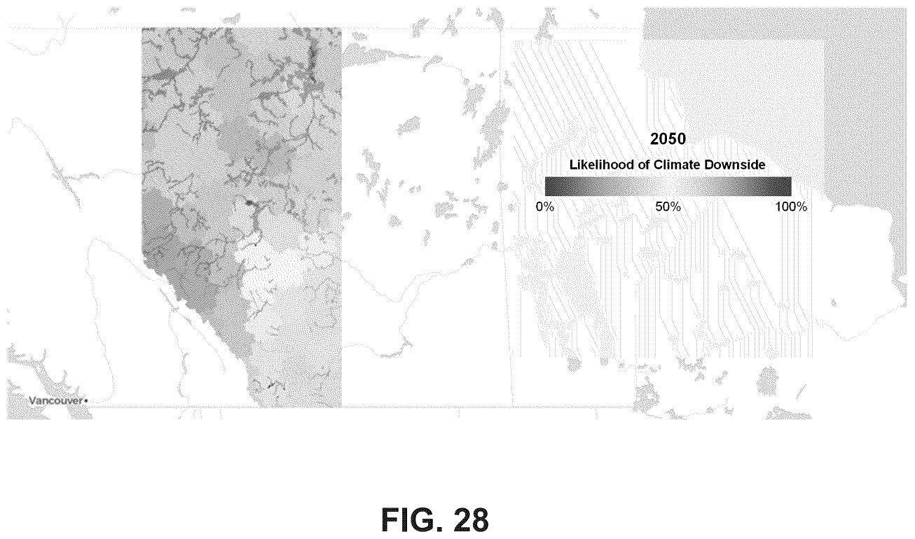

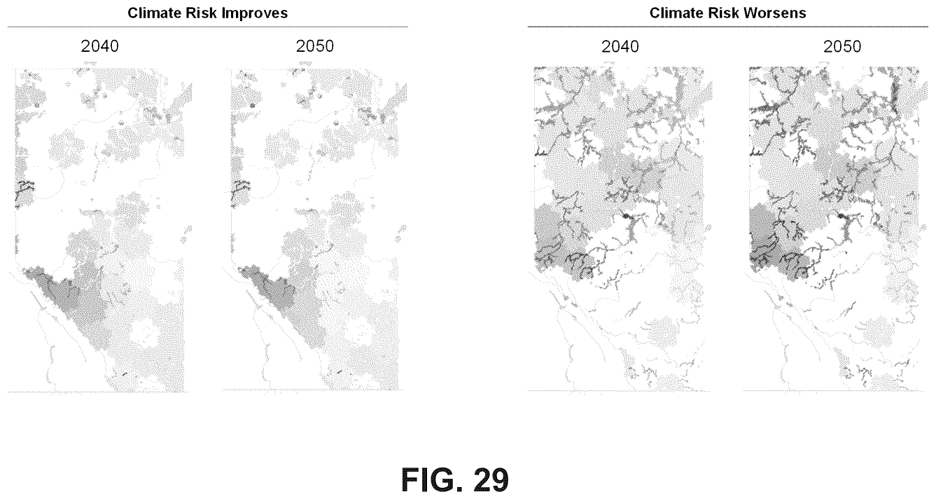

FIG. 26 shows an example interface 180 with visualizations for mapping economic activity of a location (e.g. province). FIG. 27 shows an example interface 180 with visualizations for weighting economic activity of a location. FIG. 28 shows an example interface 180 with visualizations for climate risk analysis with a map view. FIG. 29 shows an example interface 180 with visualizations for climate risk analysis with a map view showing climate risk improving and climate risk worsening.

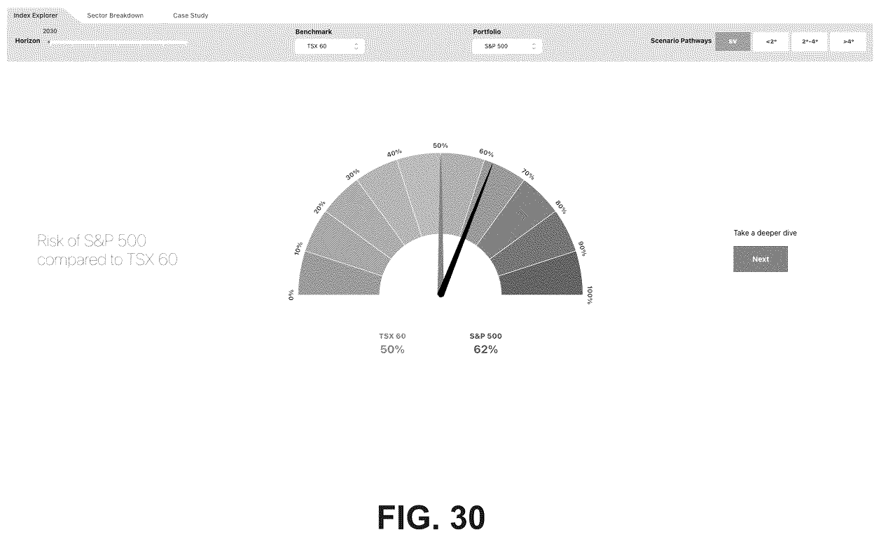

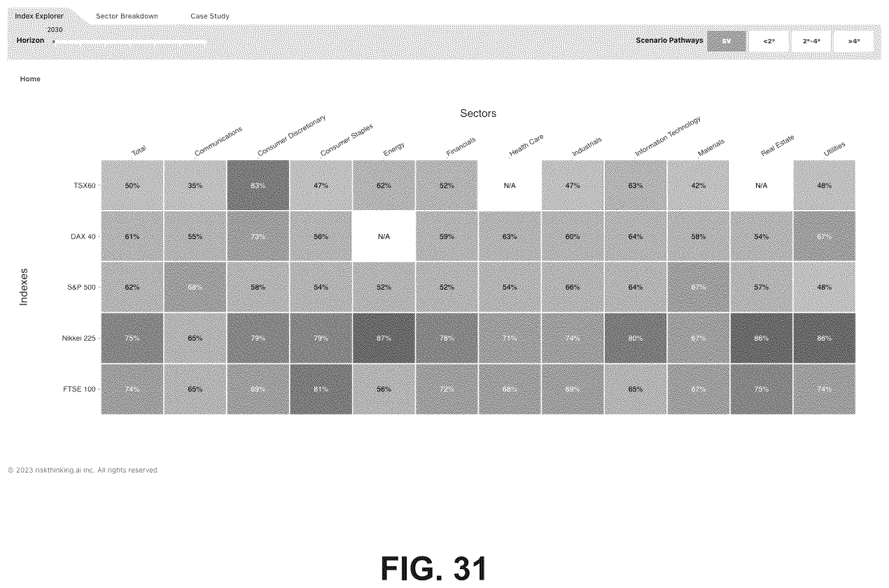

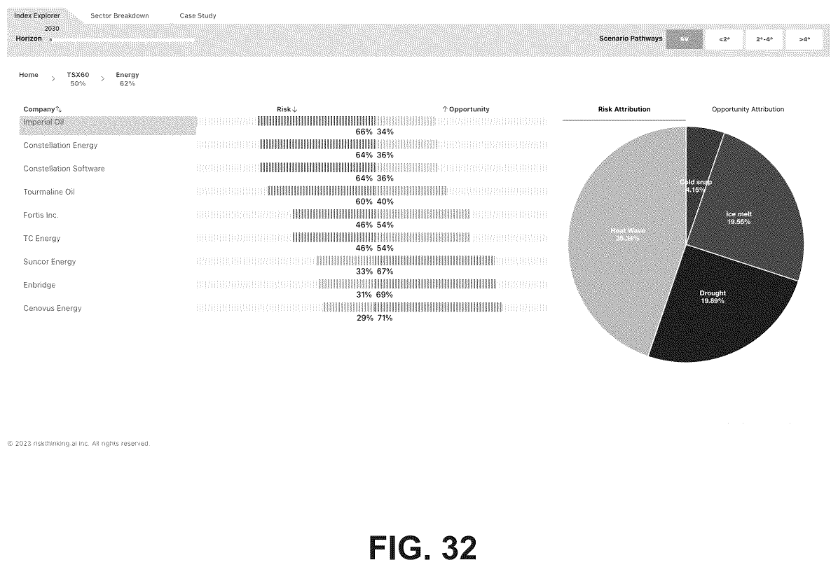

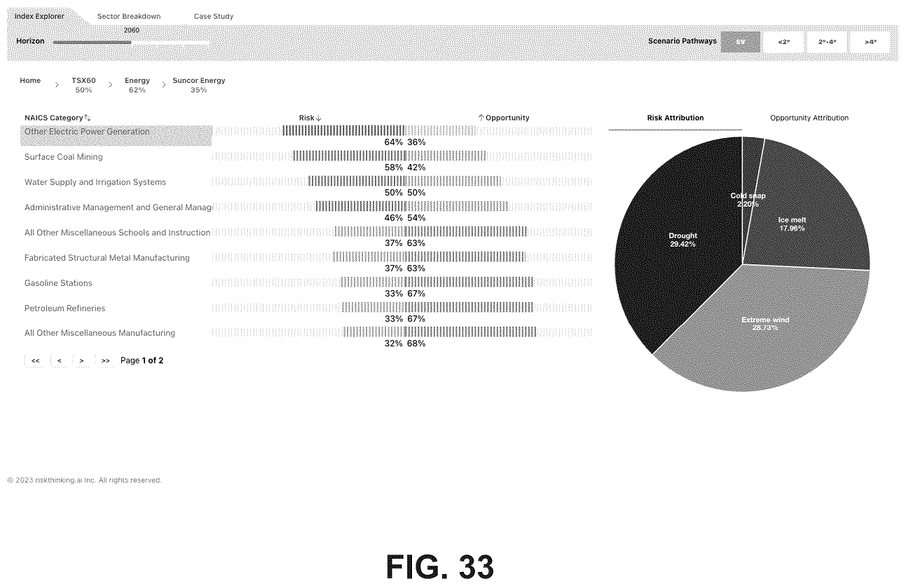

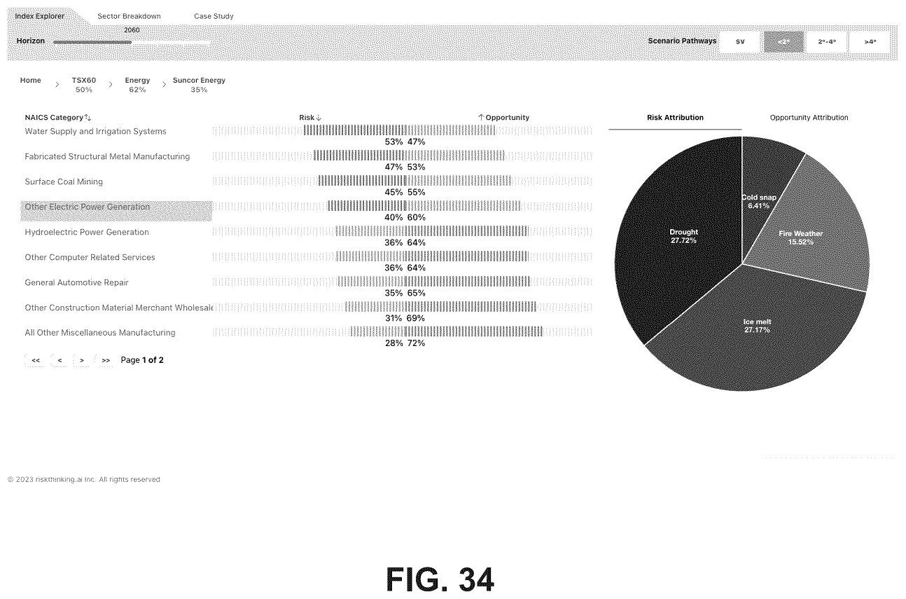

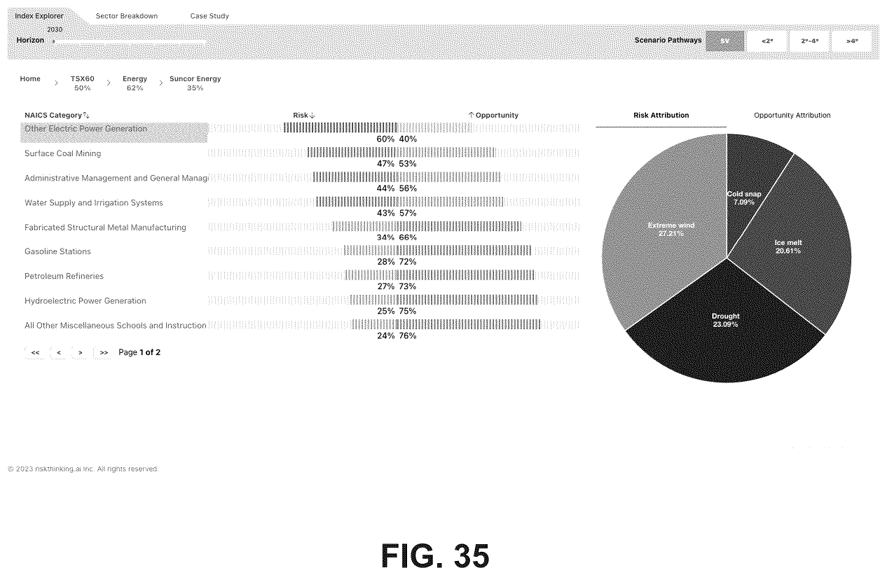

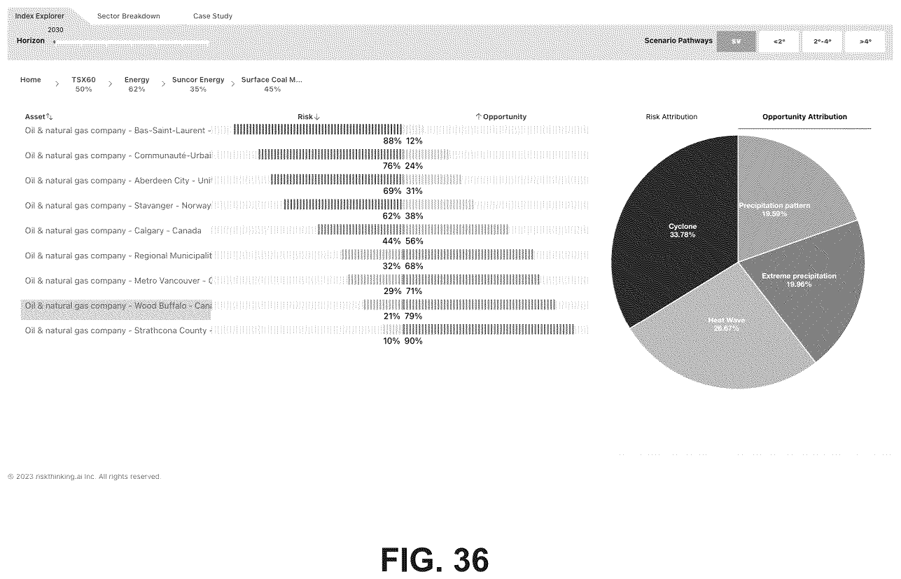

FIG. 30 shows an example interface 180 with visualizations for benchmarking risk of S&P 500 to TSX 60. FIG. 31 shows an example interface 180 with visualizations for sectors and risk indexes. FIG. 32 shows an example interface 180 with visualizations for an energy example. FIG. 33 shows an example interface 180 with visualizations for an energy example with different horizons. FIG. 34 shows an example interface 180 with visualizations for an energy example with different horizons. FIG. 35 shows an example interface 180 with visualizations for an energy example. FIG. 36 shows an example interface 180 with visualizations for an energy example with different opportunities. FIG. 33 shows an example interface 180 with visualizations for an energy example with different risk attributes.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the description, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Embodiments relate to processes implements by a computing device having at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

An example computing device includes at least one processor, memory, at least one I/O interface, and at least one network interface. A processor may be, for example, any type of microprocessor or microcontroller, a digital signal processing (DSP) processor, an integrated circuit, a field programmable gate array (FPGA), a reconfigurable processor, a programmable read-only memory (PROM), or any combination thereof. Memory may include a suitable combination of any type of computer memory that is located either internally or externally. Each I/O interface enables computing device to interconnect with one or more input devices, such as a keyboard, mouse, camera, touch screen and a microphone, or with one or more output devices such as a display screen and a speaker.

A network interface 130 enables system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computer system for physical climate risk indicators, the system comprising:
non-transitory memory storing location data, climatology data, risk factor data for different types of risk factors, and distributions of climate risk projections, wherein the different types of risk factors comprise climate risk factors, policy risk factors, and social risk factors, wherein the risk factors comprise risk indexes, wherein the risk indexes comprise the climate risk indexes, policy risk indexes, and social risk indexes, wherein the climate risk indexes comprise transition risk indexes and physical risk indexes;
a processing system of one or more hardware processors programmed with executable instructions and with a communication path to the non-transitory memory, wherein the one or more hardware processors:
construct the distributions of climate risk projections for one or more locations and one or more future climatology projections;
compute, for each climate risk factor, a risk impact and an opportunity impact, wherein the risk impact indicates a magnitude of negative impact a location is set to experience relative to a baseline, wherein the opportunity impact indicates a magnitude of positive impact the location is set to experience relative to the baseline;
compute, for each climate risk factor, an upside probability and a downside probability, the downside probability measuring a likelihood that a projection is inside a risk area relative to the baseline and the upside probability measuring a likelihood that the projection is inside an opportunity area relative to the baseline;
generate, using the distributions of climate risk projections as input, multifactor scenario sets, wherein the multifactor scenario sets represent an effect that a plurality of climate risk factors have on a physical asset over a time horizon;
generate multifactor climate risk indicators using the multifactor scenario sets, the climate risk indicators comprising factor risk indicators, factor opportunity indicators, and climate risk indicators, wherein a factor risk indicator measures a location's degree of risk exposure to a climate risk factor, wherein a factor opportunity indicator measures the location's degree of opportunity exposure to the climate risk factor, wherein a physical climate risk indicator measures the exposure of an entity or physical asset to a climate risk potential relative to an opportunity potential, wherein the physical climate risk indicators provide downside climate risk and upside climate risk of a physical asset or a group of physical assets, the downside risk defined as an impact weighted downside probability on the asset or the group of assets and the upside risk defined as an impact weighted upside probability on the asset or the group of assets;
transmit at least a portion of the multifactor climate risk indicators; and
store the multifactor climate risk indicators in the non-transitory memory;
an application programming interface to provide access to the hardware processor to provide input data and receive output data; and
a computer device with a hardware processor having a client application to transmit input data to the application programming interface and an interface to generate visual elements at least in part corresponding to the portion of the multifactor climate risk indicators received in response to the input data, wherein the interface receives input to navigate financial impact of climate risk into the future for a physical asset of an entity, for any climate pathway, for any time period.

2. The system of claim 1 wherein the one or more hardware processors construct the distributions of climate risk projections, by, for each climate risk factor, constructing forward-looking distributions of projected values for the climate risk factor for a given location and future climatology projection.

3. The system of claim 1 wherein the multifactor scenario sets account for permutations of the plurality of climate risk factors over the time horizon, wherein the multifactor scenario sets form a spanning set as a binary scenario tree of nodes, each branch of the tree representing a possible combination of climate risk factors and the upside probability and the downside probability for the climate risk factors, the spanning set having edges connecting the nodes to create climate pathways, wherein the processor constructs the spanning set to enable analysis of different types of risk indexes independently or as a combination.

4. The system of claim 1 wherein the climate risk indicators comprise physical climate risk indicators and transition economic climate risk indicators.

5. The system of claim 1 wherein the climate risk factors comprise transition (economic) risk factors and physical risk factors, wherein transition risk factors comprise energy prices for various types of energy, energy consumption by sector for various types of energy, solar capital cost, wind capital cost (offshore and onshore), GDP growth, an agriculture price index and other financial variables, wherein physical risk factors comprise heatwave, sea level rise, flood and other non-financial climate variables.

6. The system of claim 1 wherein the interface navigates the financial impact of climate risk with respect to different categories comprising a carbon category, a labour category, and a capital category.

7. The system of claim 1 wherein the hardware processor aligns the climate risk factor data geospatially, temporally, and by climate pathway.

8. The system of claim 1 wherein the hardware processor scales the climate risk factor data relative to the baseline.

9. The system of claim 1 wherein the hardware processor identifies the physical asset or the group of physical assets of the physical climate risk indicators by identifying physical assets owned or operated by each node in a corporate network of a company and generate, for each physical asset, asset attributes about asset type, emissions, financial data, ownership, physical location (latitude and longitude, country, state, postal code), and size.

10. The system of claim 1 wherein the hardware processor generates the multifactor scenario sets to measure climate financial risk using stochastic analysis.

11. The system of claim 1 wherein, for each risk factor, a node stores a quantitative value derived for the upside probability or the downside probability for the risk factor.

12. The system of claim 1 wherein the physical climate risk indicators indicate physical and transition risk exposure at any time point in the future, under any climate pathway, for the climate risk factors, for any asset location.

13. A computer method for computer models for physical climate risk indicators, the method comprising:
storing, in memory, location data, climatology data, risk factor data for different types of risk factors, and distributions of climate risk projections, wherein the different types of risk factors comprise climate risk factors, policy risk factors, and social risk factors, wherein the risk factors comprise risk indexes, wherein the risk indexes comprise the climate risk indexes, policy risk indexes, and social risk indexes, wherein the climate risk indexes comprise transition risk indexes and physical risk indexes;
using a hardware processor with a communication path to the non-transitory memory,
constructing the distributions of climate risk projections, by, for each climate risk factor, constructing forward-looking distributions of projected values for the climate risk factor for a given location and future climatology projection;
computing, for each climate risk factor, a risk impact and an opportunity impact, wherein the risk impact indicates a magnitude of negative impact a location is set to experience relative to a baseline, wherein the opportunity impact indicates a magnitude of positive impact the location is set to experience relative to the baseline;
computing, for each climate risk factor, an upside probability and a downside probability, the downside probability measuring a likelihood that a projection is inside a risk area relative to the baseline and the upside probability measuring a likelihood that the projection is inside an opportunity area relative to the baseline;
generating, using the distributions of climate risk projections as input, multifactor scenario sets, wherein the multifactor scenario sets represent an effect that a plurality of climate risk factors have on a physical asset over a time horizon, wherein the multifactor scenario sets account for permutations of the plurality of climate risk factors over the time horizon, wherein the multifactor scenario sets form a spanning set as a binary scenario tree of nodes, each branch of the tree representing a possible combination of climate risk factors and the upside probability and the downside probability for the climate risk factors, the spanning set having edges connecting the nodes to create climate pathways, wherein the spanning set enables analysis of different types of risk indexes independently or as a combination;
generating multifactor climate risk indicators using the multifactor scenario sets, the climate risk indicators comprising factor risk indicators, factor opportunity indicators, and physical climate risk indicators, wherein a factor risk indicator measures a location's degree of risk exposure to a climate risk factor, wherein a factor opportunity indicator measures the location's degree of opportunity exposure to the climate risk factor, wherein a physical climate risk indicator measures exposure of an entity or physical asset to a climate risk potential relative to an opportunity potential, wherein the physical climate risk indicators provide downside climate risk and upside climate risk of a physical asset or a group of physical assets, the downside risk defined as an impact weighted downside probability on the asset or the group of assets and the upside risk defined as an impact weighted upside probability on the asset or the group of assets, wherein the climate risk indicators comprise physical climate risk indicators and transition (economic) climate risk indicators;
transmitting at least a portion of the multifactor climate risk indicators;
storing the multifactor climate risk indicators in the non-transitory memory; and
providing access to the hardware processor using an application programming interface to provide input data and receive output data.

14. The method of claim 13 further comprising providing an interface for navigating, based on the input data, financial impact of climate risk with respect to different categories comprising carbon category, labour category, and capital category.

15. The method of claim 13 further comprising aligning the climate risk factor data geospatially, temporally, and by climate pathway.

16. The method of claim 13 further comprising scaling the climate risk factor data relative to the baseline.

17. The method of claim 13 further comprising generating the multifactor scenario sets to measure climate financial risk using stochastic analysis.

18. The method of claim 13 further comprising, storing, for each risk factor, at a node, a quantitative value derived for the upside probability or the downside probability for the risk factor.

19. The method of claim 13 further comprising displaying, at the interface, the physical climate risk indicators as indicating physical and transition risk exposure at any time point in the future, under any climate pathway, for the climate risk factors, for any asset location.

20. Non-transitory computer readable medium storing instructions for physical climate risk indicators, which when executed by a hardware processor cause the processor to implement operations comprising:
constructing the distributions of climate risk projections, by, for each climate risk factor, constructing forward-looking distributions of projected values for the climate risk factor for a given location and future climatology projection;
computing, for each climate risk factor, a risk impact and an opportunity impact, wherein the risk impact indicates a magnitude of negative impact a location is set to experience relative to a baseline, wherein the opportunity impact indicates a magnitude of positive impact the location is set to experience relative to the baseline;
computing, for each climate risk factor, an upside probability and a downside probability, the downside probability measuring a likelihood that a projection is inside a risk area relative to the baseline and the upside probability measuring a likelihood that the projection is inside an opportunity area relative to the baseline;
generating, using the distributions of climate risk projections as input, multifactor scenario sets, wherein the multifactor scenario sets represent an effect that a plurality of climate risk factors have on a physical asset over a time horizon, wherein the multifactor scenario sets account for permutations of the plurality of climate risk factors over the time horizon, wherein the multifactor scenario sets form a spanning set as a binary scenario tree of nodes, each branch of the tree representing a possible combination of climate risk factors and the upside probability and the downside probability for the climate risk factors, the spanning set having edges connecting the nodes to create climate pathways;
generating multifactor climate risk indicators using the multifactor scenario sets, the climate risk indicators comprising factor risk indicators, factor opportunity indicators, and physical climate risk indicators, wherein a factor risk indicator measures a location's degree of risk exposure to a climate risk factor, wherein a factor opportunity indicator measures the location's degree of opportunity exposure to the climate risk factor, wherein a physical climate risk indicator measures exposure of an entity or physical asset to a climate risk potential relative to an opportunity potential, wherein the physical climate risk indicators provide downside climate risk and upside climate risk of a physical asset or a group of physical assets, the downside risk defined as probability weighted downside impact on the asset or the group of assets and the upside risk defined as probability weighted upside impact on the asset or the group of assets;
transmitting at least a portion of the multifactor climate risk indicators;
storing the multifactor climate risk indicators in the non-transitory memory; and
providing access to the hardware processor using an application programming interface to provide input data and receive output data.
